(19) United States
(12) Patent Application Publication
(10) Pub. No.: US 2009/0181760 A1
(43) Pub. Date: Jul. 16, 2009

(54) GAMING DEVICE EXECUTING GAME PROGRAM BASED ON FORM OF INPUT FROM OUTSIDE AND PLAYING METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/173,563

(22) Filed: Jul. 15, 2008

Related U.S. Application Data
(60) Provisional application No. 61/020,813, filed on Jan. 14, 2008.

(51) Int. Cl. A63F 13/00; A63F 9/24

(52) U.S. Cl. 463/25

(57) ABSTRACT

In a Derby game in which a bet of a game value on a BET object is received, either of a first game having a possibility that a bonus payout will be awarded or a second game having no possibility that a bonus payout will be awarded is executed in accordance with an input form of a BET form switch capable of accepting at least two forms from an outside.

### CROSS REFERENCE TO RELATED APPLICATION

This application claims the benefit of U.S. Provisional Application No. 61/020,813, filed on Jan. 14, 2008, which application is incorporated herein by reference in its entirety.

### BACKGROUND OF THE INVENTION

1. Field of the Invention

The invention relates to a gaming device and a playing method thereof.

2. Description of Related Art

A gaming machine has been known which allows many players to make a bet from a client terminal while using a common screen, thereby playing a game. For example, US2005/0059474 A1, US2005/0282618 A1 and US2005/0218590 A1 disclose a gaming device having a number of consoles, a central controller and a common display unit connected thereto.

In the above gaming device, a player bets a game value such as coin on several BET objects. Based on an execution result of a game, a BET object having a win is determined. When the BET object on which the player bets is same as the BET object having a win (referred to as “win BET object”), a payout is awarded to the player.

An object of the present invention is to provide a gaming device having an entertainment characteristic, which is not provided to the conventional gaming device, and a playing method thereof.

In addition, another object of the invention is to give a player an expectation that a bonus payout may be awarded, in addition to the characteristic of the conventional game, without deteriorating conventional game characteristics.

### SUMMARY OF THE INVENTION

The present invention provides a gaming device including: a game in which a player is able to bet a game value on a BET object;

a BET receiver that receives, from an outside, a bet of the game value on the BET object, as a base BET when an operation of betting the game value on the BET object is a base operation and as a special BET when an operation of betting the game value on the BET object is a special operation; and

a controller programmed to operate:

(a1) regarding a payout ratio corresponding to the BET object, to set a payout ratio for a bet made as the base BET so as to be different from a payout ratio for a bet made as the special BET;

(a2) to control the BET receiver to receive a bet of the game value on the BET object from the outside, as the base BET, when an operation of betting the game value on the BET object is a base operation, and as the special BET, when an operation of betting the game value on the BET object is a special operation;

(a3) to determine a win BET object from the BET objects, based on an execution result of the game;

(a4) when the win BET object is same as the BET object bet, to award a payout, based on the payout ratio corresponding to the BET object bet and the game value that is bet on the BET object bet;

(a5) when the win BET object is same as the BET object bet as the special BET, to randomly determine whether to award a bonus payout; and

(a6) when it is determined that the bonus payout is awarded, to award the bonus payout.

According to the above structure, regarding a payout ratio corresponding to a BET object, a payout ratio for a bet made as a base BET is set so as to be different from a payout ratio for a bet made as a special BET. The BET receiver is controlled to receive a bet of the game value on a BET object from an outside, as a base BET, when an operation of betting the game value on the BET object is a base operation, and as a special BET, when an operation of betting the game value on the BET object is a special operation. Based on an execution result of a game, a win BET object is determined from the BET objects. When the win BET object is same as the BET object bet, a payout is awarded, based on the payout ratio corresponding to the BET object bet and the game value that is bet on the BET object bet. When the win BET object is same as the BET object bet as the special BET, it is randomly determined whether to award a bonus payout. When it is determined that the bonus payout is awarded, the bonus payout is awarded.

Accordingly, a game can be provided in which by making a bet on a BET object as a special BET, an award of a bonus payout may be determined although a payout ratio for the bet made as a special BET is different from a payout ratio for the bet made as a base BET. Therefore, it is possible to give a player an expectation that a bonus payout may be awarded, in addition to the characteristics of a conventional game, without deteriorating the conventional game characteristic.

The present invention provides a gaming device including: a game in which a player is able to bet a game value on a BET object;

a BET receiver that receives, from an outside, a bet of the game value on the BET object, as a base BET when an operation of betting the game value on the BET object is a base operation and as a special BET when an operation of betting the game value on the BET object is a special operation; and

a controller programmed to operate:

(b1) regarding a payout ratio corresponding to the BET object, to set a payout ratio for a bet made as the special BET so as to be smaller than a payout ratio for a bet is made as the base BET;

(b2) to control the BET receiver to receive a bet of the game value on the BET object from the outside, as the base BET, when an operation of betting the game value on the BET object is a base operation, and as the special BET, when an operation of betting the game value on the BET object is a special operation;

(b3) to determine a win BET object from the BET objects, based on an execution result of the game;

(b4) when the win BET object is same as the BET object bet, to award a payout, based on the payout ratio corresponding to the BET object bet and the game value that is bet on the BET object bet;

(b5) when the win BET object is same as the BET object bet as the special BET, to randomly determine whether to award a bonus payout; and

(b6) when it is determined that the bonus payout is awarded, to award the bonus payout.

According to the above structure, a payout ratio corresponding to a BET object on which a bet is made as a special BET is set so as to be smaller than a payout ratio corresponding to a BET object on which a bet is made as a base BET. The BET receiver is controlled to receive a bet of the game value on the BET object from an outside, as a base BET, when an operation of betting the game value on the BET object is a base operation, and as a special BET, when an operation of betting the game value on the BET object is a special operation. Based on an execution result of a game, a win BET object is determined from the BET objects. When the win BET object is same as the BET object bet, a payout is awarded, based on the payout ratio corresponding to the BET object bet and the game value that is bet on the BET object bet. When the win BET object is same as the BET object bet as the special BET, it is randomly determined whether to award a bonus payout. When it is determined that the bonus payout is awarded, the bonus payout is awarded.

Accordingly, a game can be provided in which by making a bet on a BET object as a special BET, an award of a bonus payout may be determined although a payout ratio of the special BET is smaller than a payout ratio of the base BET. Therefore, it is possible to give a player an expectation that a bonus payout may be awarded, in addition to the characteristics of a conventional game, without deteriorating the conventional game characteristic.

Furthermore, by setting a payout ratio of the special BET to be smaller than a payout ratio of the base BET, a payout corresponding to a difference between the payout ratio of the base BET and the payout ratio of the special BET can be provided as a bonus payout. Therefore, this may decrease the possibility that the earnings of a game arcade are reduced due to an award of a bonus payout.

The present invention provides a gaming device including: a game in which a player is able to bet a game value on a BET object;

a BET receiver that receives, from an outside, a bet of the game value on the BET object, as a base BET when an operation of betting the game value on the BET object is a base operation and as a special BET when an operation of betting the game value on the BET object is a special operation; and

a controller programmed to operate:

(c1) regarding a payout ratio corresponding to the BET object, to set a payout ratio for a bet made as the base BET so as to be different from a payout ratio for a bet made as the special BET;

(c2) to control the BET receiver to receive a bet of the game value on the BET object from the outside, as the base BET, when an operation of betting the game value on the BET object is a base operation, and as the special BET, when an operation of betting the game value on the BET object is a special operation;

(c3) to determine a win BET object from the BET objects, based on an execution result of the game;

(c4) when the win BET object is same as the BET object bet, to award a payout, based on the payout ratio corresponding to the BET object bet and the game value that is bet on the BET object bet;

(c5) when the win BET object is same as the BET object bet as the special BET, to control the BET receiver to receive a bet of the game value;

(c6) to randomly determine whether to award a bonus payout, based on whether or not the bet of the game value has been made; and

(c7) when it is determined that the bonus payout is awarded, to award the bonus payout.

According to the above structure, regarding a payout ratio corresponding to a BET object, a payout ratio for a bet made as a base BET is set so as to be different from a payout ratio for a bet made as a special BET. The BET receiver is controlled to receive a bet of the game value on the BET object from an outside, as a base BET, when an operation of betting the game value on the BET object is a base operation, and as a special BET, when an operation of betting the game value on the BET object is a special operation. Based on an execution result of a game, a win BET object is determined from the BET objects. When the win BET object is same as the BET object bet, a payout is awarded, based on the payout ratio corresponding to the BET object bet and the game value that is bet on the BET object bet. When the win BET object is same as the BET object bet as the special BET, the BET receiver is controlled to receive a bet of the game value, and it is randomly determined whether to award a bonus payout, based on whether or not the bet of the game value has been made. When it is determined that the bonus payout is awarded, the bonus payout is awarded.

Accordingly, a game can be provided in which by making a bet on a BET object as a special BET, an award of a bonus payout may be determined although a payout ratio for the bet made as a special BET is different from a payout ratio for the bet made as a base BET. Therefore, it is possible to give a player an expectation that a bonus payout may be awarded, in addition to the characteristics of a conventional game, without deteriorating the conventional game characteristic.

Furthermore, the bonus payout is determined on the basis of whether or not the bet of game value has been made. This encourages a player to bet a game value so that the bonus payout is determined.

The present invention provides a gaming device according to claim 3, in which the controller is programmed to operate:

(d1) regarding a payout ratio corresponding to the BET object, to set a payout ratio for a bet made as the special BET so as to be smaller than a payout ratio for a bet made as the base BET;

(d2) to control the BET receiver to receive a bet of the game value on the BET object from the outside, as the base BET, when an operation of betting the game value on the BET object is a base operation, and as the special BET, when an operation of betting the game value on the BET object is a special operation;

(d3) to determine a win BET object from the BET objects, based on an execution result of the game;

(d4) when the win BET object is same as the BET object bet, to award a payout, based on the payout ratio corresponding to the BET object bet and the game value that is bet on the BET object bet;

(d5) when the win BET object is same as the BET object bet as the special BET, to control the BET receiver to receive a bet of the game value;

(d6) to randomly determine whether to award a bonus payout, based on whether or not the bet of the game value has been made; and

(d7) when it is determined that the bonus payout is awarded, to award the bonus payout.

According to the above structure, a payout ratio corresponding to a BET object on which a bet is made as a special BET is set so as to be smaller than a payout ratio corresponding to a BET object on which a bet is made as a base BET. The BET receiver is controlled to receive a bet of the game value the a BET object from an outside, as a base BET, when an operation of betting the game value on the BET object is a base operation, and as a special BET, when an operation of betting the game value on the BET object is a special operation. Based on an execution result of a game, a win BET object is determined from the BET objects. When the win BET object is same as the BET object bet, a payout is awarded, based on the payout ratio corresponding to the BET object bet and the game value that is bet on the BET object bet. When the win BET object is same as the BET object bet as the special BET, the BET receiver is controlled to receive a bet of the game value and it is randomly determined whether to award a bonus payout, base on whether or not the bet of the game value has been made. When it is determined that the bonus payout is awarded, the bonus payout is awarded.

Accordingly, a game can be provided in which by making a bet on a BET object as a special BET, an award of a bonus payout may be determined although a payout ratio of the special BET is smaller than a payout ratio of the base BET. Therefore, it is possible to give a player an expectation that a bonus payout may be awarded, in addition to the characteristics of a conventional game, without deteriorating the conventional game characteristic.

Furthermore, the bonus payout is determined on the basis of whether or not the bet of game value has been made. This encourages a player to bet a game value so that the bonus payout is determined.

Furthermore, by setting a payout ratio of the special BET to be smaller than a payout ratio of the base BET, a payout corresponding to a difference between the payout ratio of the base BET and the payout ratio of the special BET can be provided as a bonus payout. Therefore, this may decrease the possibility that the earnings of a game arcade are reduced due to an award of a bonus payout.

The present invention provides a gaming device including: a game in which a racer is able to race and a player is able to bet a game value on a BET object corresponding to a result of the race;

a display capable of displaying an effect about the game;

a BET receiver that receives, from an outside, a bet of the game value on the BET object, as a base BET, when an operation of betting the game value on the BET object is a base operation, and as a special BET, when an operation of betting the game value on the BET object is a special operation; and

a controller programmed to operate:

(e1) regarding a payout ratio corresponding to the BET object, to set a payout ratio for a bet made as the base BET so as to be different from a payout ratio for a bet made as the special BET;

(e2) to control the BET receiver to receive a bet of the game value on the BET object from the outside, as the base BET, when an operation of betting the game value on the BET object is a base operation, and as the special BET, when an operation of betting the game value on the BET object is a special operation;

(e3) to determine a win BET object from the BET objects, based on an execution result of the game;

(e4) when the win BET object is same as the BET object bet, to award a payout, based on the payout ratio corresponding to the BET object bet and the game value that is bet on the BET object bet;

(e5) when the win BET object is same as the BET object bet as the special BET, to control the BET receiver to receive a bet of the game value and to control the display to display an effect in which the racer intends to acquire a bonus payout;

(e6) when the bet of the game value is received, to control the display to display an effect in which it is advantageous for the racer to acquire the bonus payout;

(e7) to randomly determine whether to award a bonus payout, based on whether or not the bet of the game value has been made; and

(e8) when it is determined that the bonus payout is awarded, to award the bonus payout.

According to the above structure, regarding a payout ratio corresponding to a BET object, a payout ratio for a bet made as a base BET is set so as to be different from a payout ratio for a bet made as a special BET. The BET receiver is controlled to receive a bet of the game value on the BET object from an outside, as a base BET, when an operation of betting the game value on the BET object is a base operation, and as a special BET, when an operation of betting the game value on the BET object is a special operation. Based on an execution result of a game, a win BET object is determined from the BET objects. When the win BET object is same as the BET object bet, the BET receiver is controlled to receive a bet of the game value and the display is controlled to display an effect in which the racer intends to acquire a bonus payout. When the bet of the game value is received, the display is controlled to display an effect in which it is advantageous for the racer to acquire the bonus payout. Based on whether or not the bet of the game value has been made, it is randomly determined whether to award a bonus payout. When it is determined that the bonus payout is awarded, the bonus payout is awarded.

Accordingly, a game can be provided in which by making a bet on a BET object as a special BET, an award of a bonus payout may be determined although a payout ratio for the bet made as a special BET is different from a payout ratio for the bet made as a base BET. Therefore, it is possible to give a player an expectation that a bonus payout may be awarded, in addition to the characteristics of a conventional game, without deteriorating the conventional game characteristic.

Furthermore, the bonus payout is determined on the basis of whether or not the bet of game value has been made. This encourages a player to bet a game value so that the bonus payout is determined.

Furthermore, an effect in which a racer intends to acquire a bonus payout and an effect in which it is advantageous for the racer to acquire the bonus payout are displayed on the display, This encourages a player to bet a game value. In addition, this may cause the player to feel a strong attachment to the racer.

The “racer” includes a competitor and a racehorse and means a competition in a broad sense.

The present invention provides a gaming device including: a game in which a racer is able to race and a player is able to bet a game value on a BET object corresponding to a result of the race;

a display capable of displaying an effect about the game;

a BET receiver that receives, from an outside, a bet of the game value on the BET object, as a base BET, when an operation of betting the game value on the BET object is a base operation, and as a special BET, when an operation of betting the game value on the BET object is a special operation; and

a controller programmed to operate:

(f1) regarding a payout ratio corresponding to the BET object, to set a payout ratio for a bet made as the base BET so as to be smaller than a payout ratio for a bet made as the special BET;

(f2) to control the BET receiver to receive a bet of the game value on the BET object from the outside, as the base BET, when an operation of betting the game value on the BET object is a base operation, and as the special BET, when an operation of betting the game value on the BET object is a special operation;

(f3) to determine a win BET object from the BET objects, based on an execution result of the game;

(f4) when the win BET object is same as the BET object bet, to award a payout, based on the payout ratio corresponding to the BET object bet and the game value that is bet on the BET object bet;

(f5) when the win BET object is same as the BET object bet as the special BET, to control the BET receiver to receive a bet of the game value and to control the display to display an effect in which the racer intends to acquire a bonus payout;

(f6) when the bet of the game value is received, to control the display to display an effect in which it is advantageous for the racer to acquire the bonus payout;

(f7) to randomly determine whether to award a bonus payout, based on whether or not the bet of the game value has been made; and

(f8) when it is determined that the bonus payout is awarded, to award the bonus payout.

According to the above structure, a payout ratio corresponding to a BET object on which a bet is made as a special BET is set so as to be smaller than a payout ratio corresponding to a BET object on which a bet is made as a base BET. The BET receiver is controlled to receive a bet of the game value on the BET object from an outside, as a base BET, when an operation of betting the game value on the BET object is a base operation, and as a special BET, when an operation of betting the game value on the BET object is a special operation. Based on an execution result of a game, a win BET object is determined from the BET objects. When the win BET object is same as the BET object bet, the BET receiver is controlled to receive a bet of the game value and the display is controlled to display an effect in which the racer intends to acquire a bonus payout. When the bet of the game value is received, the display is controlled to display an effect in which it is advantageous for the racer to acquire the bonus payout. Based on whether or not the bet of the game value has been made, it is randomly determined whether to award a bonus payout. When it is determined that the bonus payout is awarded, the bonus payout is awarded.

Accordingly, a game can be provided in which by making a bet on a BET object as a special BET, an award of a bonus payout may be determined although a payout ratio of the special BET is smaller than a payout ratio of the base BET. Therefore, it is possible to give a player an expectation that a bonus payout will be awarded, in addition to the characteristics of a conventional game, without deteriorating the conventional game characteristic.

Furthermore, the bonus payout is determined on the basis of whether or not the bet of game value has been made. This encourages a player to bet a game value so that the bonus payout is determined.

Furthermore, an effect in which a racer intends to acquire a bonus payout and an effect in which it is advantageous for the racer to acquire the bonus payout are displayed on the display, This encourages a player to bet a game value. In addition, this may cause the player to feel a strong attachment to the racer.

Furthermore, a payout ratio of the special BET is smaller than a payout ratio of the base BET, so that a payout corresponding to a difference between a payout ratio of the base BET and a payout ratio of the special BET can be awarded as a bonus payout. Therefore, this may decrease the possibility that the earnings of a game arcade are reduced due to an award of a bonus payout.

Further, a payout ratio of the special BET is smaller than a payout ratio of the base BET and a bonus award is determined on the basis of whether or not a bet of a game value has been made. This may encourage a player, who wants to acquire a payout based on a payout ratio of a base BET, to bet a game value.

The present invention provides a playing method of a gaming device having a game in which a player is able to bet a game value on a BET object, the method including the steps of:

(g1) with regard to a payout ratio corresponding to the BET object, setting a payout ratio for a bet made as a base BET so as to be different from a payout ratio for a bet made as a special BET;

(g2) controlling a BET receiver to receive a bet of the game value on the BET object from the outside, as the base BET, when an operation of betting the game value on the BET object is a base operation, and as the special BET, when an operation of betting the game value on the BET object is a special operation;

(g3) determining a win BET object from the BET objects, based on an execution result of the game;

(g4) when the win BET object is same as the BET object bet, awarding a payout, based on the payout ratio corresponding to the BET object bet and the game value that is bet on the BET object bet;

(g5) when the win BET object is same as the BET object bet as the special BET, randomly determining whether to award a bonus payout; and

(g6) when it is determined that the bonus payout is awarded, awarding the bonus payout.

According to the above structure, regarding a payout ratio corresponding to a BET object, a payout ratio for a bet made as a base BET is set so as to be different from a payout ratio for a bet made as a special BET. The BET receiver is controlled to receive a bet of the game value on the BET object from an outside, as a base BET, when an operation of betting the game value on the BET object is a base operation, and as a special BET, when an operation of betting the game value on the BET object is a special operation. Based on an execution result of a game, a win BET object is determined from the BET objects. When the win BET object is same as the BET object bet, a payout is awarded, based on the payout ratio corresponding to the BET object bet and the game value that is bet on the BET object bet. When the win BET object is same as the BET object bet as the special BET, it is randomly determined whether to award a bonus payout. When it is determined that the bonus payout is awarded, the bonus payout is awarded.

Accordingly, a game can be provided in which by making a bet on a BET object as a special BET, an award of a bonus payout may be determined although a payout ratio for the bet made as a special BET is different from a payout ratio for the bet made as a base BET. Therefore, it is possible to give a player an expectation that a bonus payout may be awarded, in addition to the characteristics of a conventional game, without deteriorating the conventional game characteristic

The present invention provides a gaming device including: a game in which a player is able to bet a game value on a BET object;

a switch capable of accepting at least two forms from an outside;

a BET receiver that receives, from the outside, a bet of the game value on the BET object; a memory device that stores a first game program executing the game having a possibility that a bonus payout may be awarded and a second game program executing the game having no possibility that a bonus payout is awarded; and

a controller programmed to operate:

(h1) to control the BET receiver to receive a bet of the game value on the BET object from the outside;

(h2) when an input form of the switch is one form, to execute the first game program stored in the memory device, and when an input form of the switch is an other form, to execute the second game program stored in the memory device;

(h3) to determine a win BET object from the BET objects, based on an execution result of the first or second game program;

(h4) when the win BET object is same as the BET object bet, to award a payout, based on a predetermined condition;

(h5) when the second game program is executed and the win BET object is same as the BET object bet, to randomly determine whether to award a bonus payout; and

(h6) when it is determined that the bonus payout is awarded, to award the bonus payout.

According to the above structure, the BET receiver is controlled to receive a bet of the game value on a BET object from an outside. When an input form of the switch is one form, a first game program stored in a memory device is executed. On the other hand, when an input form of the switch is an other form, a second game program stored in the memory device is executed. Based on an execution result of the first or second game program, a win BET object is determined from the BET objects. When the win BET object is same as the BET object bet, a payout is awarded, based on a predetermined condition. When the second game program is executed and the win BET object is same as the BET object bet, it is randomly determined whether to award a bonus payout. When it is determined that the bonus payout is awarded, the bonus payout is awarded.

Therefore, when a player sets an input form of the switch as one form, a game having a possibility that a bonus payout may be awarded is executed. When a player sets an input form of the switch as an other form, a game having no possibility that a bonus payout is awarded is executed. Accordingly, it is possible to give a player an expectation that a bonus payout may be awarded, in addition to the characteristics of a conventional game, without deteriorating the conventional game characteristic.

The present invention provides a gaming device including: a game in which a player is able to bet a game value on a BET object;

a switch capable of accepting at least two forms from an outside;

a BET receiver that receives, from the outside, a bet of the game value on the BET object; a memory device that stores a first game program executing the game having a possibility that a bonus payout may be awarded and a second game program executing the game having no possibility that a bonus payout is awarded; and

a controller programmed to operate:

(i1) to control the BET receiver to receive a bet of the game value on the BET object from the outside;

(i2) when an input form of the switch is one form, to execute the first game program stored in the memory device, and when an input form of the switch is an other form, to execute the second game program stored in the memory device;

(i3) to determine a win BET object from the BET objects, based on an execution result of the first or second game program;

(i4) when the win BET object is same as the BET object bet, to award a payout, based on a predetermined condition;

(i5) when the second game program is executed and the win BET object is same as the BET object bet, to control the BET receiver to receive a bet of the game value;

(i6) to randomly determine whether to award a bonus payout, based on whether or not a bet of the game value has been made; and

(i7) when it is determined that the bonus payout is awarded, to award the bonus payout.

According to the above structure, the BET receiver is controlled to receive a bet of the game value on a BET object from an outside. When an input form of the switch is one form, a first game program stored in a memory device is executed. On the other hand, when an input form of the switch is an other form, a second game program stored in the memory device is executed. Based on an execution result of the first or second game program, a win BET object is determined from the BET objects. When the win BET object is same as the BET object bet, a payout is awarded, based on a predetermined condition. When the second game program is executed and the win BET object is same as the BET object bet, the BET receiver is controlled to receive a bet of the game value. It is randomly determined whether to award a bonus payout, based on whether or not a bet of the game value has been made. When it is determined that the bonus payout is awarded, the bonus payout is awarded.

Therefore, when a player sets an input form of the switch as one form, a game having a possibility that a bonus payout may be awarded is executed. When a player sets an input form of the switch as an other form, a game having no possibility that a bonus payout is awarded is executed. Accordingly, it is possible to give a player an expectation that a bonus payout may be awarded, in addition to the characteristics of a conventional game, without deteriorating the conventional game characteristic.

Furthermore, the bonus payout is determined on the basis of whether or not the bet of game value has been made. This encourages a player to bet a game value so that the bonus payout is determined.

The present invention provides a playing method of a gaming device having a game in which a player is able to bet a game value on a BET object, the method comprising the steps of:

(j1) controlling a BET receiver to receive a bet of the game value on the BET object from an outside;

(j2) when an input form of a switch capable of accepting at least two forms from an outside is one form, executing a first game program executing the game having a possibility that a bonus payout may be awarded, and when an input form of the switch is an other form, executing a second game program executing the game having no possibility that a bonus payout is awarded;

(j3) determining a win BET object from the BET objects, based on an execution result of the first or second game program;

(j4) when the win BET object is same as the BET object bet, awarding a payout, based on a predetermined condition;

(j5) when the second game program is executed and the win BET object is same as the BET object bet, randomly determining whether to award a bonus payout; and

(j6) when it is determined that the bonus payout is awarded, awarding the bonus payout.

According to the above structure, the BET receiver is controlled to receive a bet of the game value on a BET object from an outside. When an input form of the switch is one form, a first game program stored in a memory device is executed. On the other hand, when an input form of the switch is an other form, a second game program stored in the memory device is executed. Based on an execution of the first or second game program, a win BET object is determined from the BET objects. When the win BET object is same as the BET object bet, a payout is awarded, based on a predetermined condition. When the second game program is executed and the win BET object is same as the BET object bet, it is randomly determined whether to award a bonus payout. When it is determined that the bonus payout is awarded, the bonus payout is awarded.

Therefore, when a player sets an input form of the switch as one form, a game having a possibility that a bonus payout may be awarded is executed. When a player sets an input form of the switch as an other form, a game having no possibility that a bonus payout is awarded is executed. Accordingly, it is possible to give a player an expectation that a bonus payout may be awarded, in addition to the characteristics of a conventional game, without deteriorating the conventional game characteristic.

### BRIEF DESCRIPTION OF THE DRAWINGS

FIG. 1 illustrates a playing method of a gaming device 10.

FIG. 2 is a block diagram of a gaming device 10.

FIG. 3 is a perspective view of a gaming device 10 and illustrates display contents of a display 101.

FIG. 4 illustrates a relation between an execution of a game and a display state of a display 101.

FIG. 5 illustrates a bonus payout effect that is displayed on a display 101B.

FIG. 6 is a block diagram showing an electrical structure of a gaming machine main body 1.

FIG. 7 is a block diagram showing an electrical structure of a terminal device 400.

FIG. 8 illustrates a racer table.

FIG. 9 illustrates a bonus determination table (base).

FIG. 10 illustrates a bonus determination table (advantage).

FIG. 11 illustrates a terminal device management table.

FIG. 12 is a flow chart showing a main process routine in a main body executed by a main CPU 41.

FIG. 13 is a flow chart showing a payout-number calculating process routine that is executed by a main CPU 41.

FIG. 14 is a flow chart showing a BET process routine that is executed by a main CPU 41.

FIG. 15 is a flow chart showing a bonus payout determining process routine that is executed by a main CPU 41.

FIG. 16 is a flow chart showing a process routine in a terminal executed by a terminal CPU 241.

### DESCRIPTION OF THE PREFERRED EMBODIMENTS

Hereinafter, an embodiment of a gaming device and a playing method thereof according to the present invention will be described.

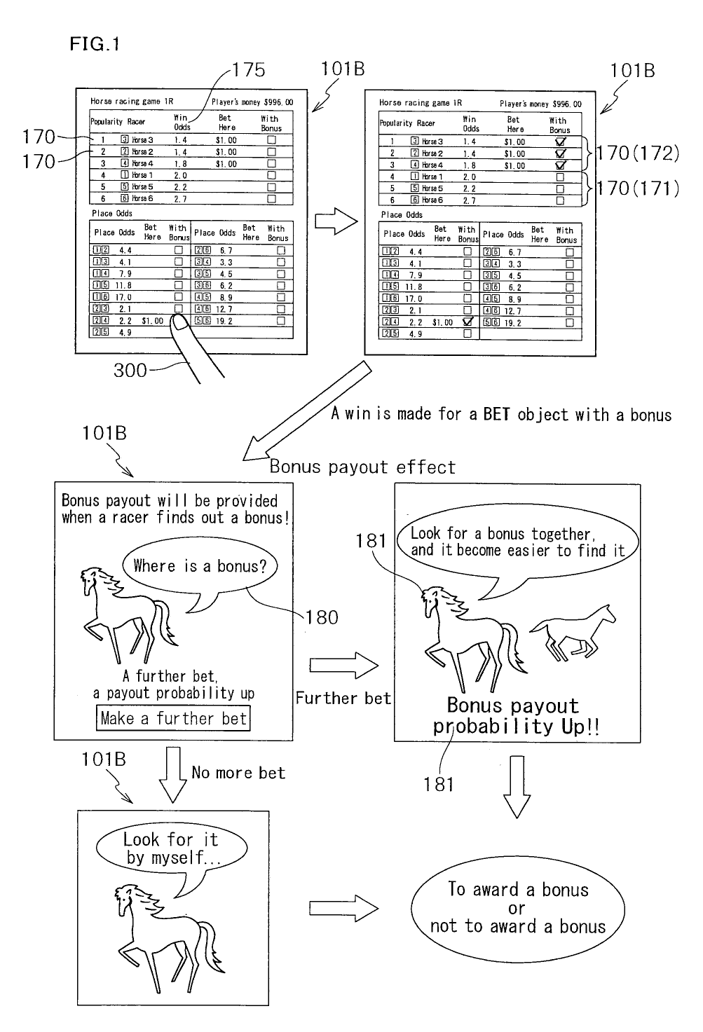

As shown in FIG. 1, a gaming device 10 executes a playing method including the steps of:

regarding a payout ratio 175 corresponding to a BET object 170, setting a payout ratio 177 for a bet made as a special BET 172 so as to be smaller than a payout ratio 176 for a bet made as a base BET 171;

controlling a BET receiver 400 to receive a bet of a game value on the BET object 170 from an outside, as the base BET 171, when an operation of betting the game value on the BET object 170 is a base operation, and as the special BET 172, when an operation of betting the game value on the BET object 170 is a special operation;

determining a win BET object 173 from the BET objects 170, based on an execution result of a game;

when the win BET object 173 is same as the BET object 170 bet, awarding a payout, based on the payout ratio 175 corresponding to the BET object 170 bet and the game value that is bet on the BET object 170 bet;

when the win BET object 173 is same as the BET object 170 bet as the special BET 172, controlling the BET receiver 400 to receive the bet of the game value and controlling a display 101 to display an effect 180 in which a racer intends to acquire a bonus payout;

when the bet of the game value is received, controlling the display 101 to display an effect 181 in which it is advantageous for the racer to acquire a bonus payout;

randomly determining whether to award a bonus payout, based on whether or not the bet of the game value has been made; and

when it is determined that the bonus payout is awarded, awarding the bonus payout.

In other words, the gaming device 10 executes a playing method including the steps of:

controlling a BET receiver 400 to receive a bet of the game value on a BET object 170 from an outside;

when an input form of a BET form switch 227 capable of accepting at least two forms from an outside is one form, executing a first game program that executes a game having a possibility that a bonus payout may be awarded, and when an input form of the switch 227 is another form, executing a second game program that executes a game having no possibility that a bonus payout is awarded;

determining a win BET object 173 from the BET objects 170, based on an execution result of the first or second game program;

when the win BET object 173 is same as the BET object 170 bet, awarding a payout, based on a predetermined condition;

when the second game program is executed and the win BET object 173 is same as the BET object 170 bet, controlling the BET receiver 400 to receive a bet of the game value;

randomly determining whether to award a bonus payout, based on whether or not the bet of the game value has been made; and

when it is determined that the bonus payout is awarded, awarding the bonus payout.

Here, the “BET object” is an object on which a player bets a game value. The “BET object bet” means a BET object on which a player bets a game value.

The “BET object as a base BET” and the “base BET” means a BET object on which a bet is made and on which a game value is bet in a base operation. In the mean time, the “BET object as a special BET” and the “special BET” means a BET object on which a bet is made and on which a game value is bet in a special operation.

The “win BET object” is a BET object that is determined as a win among the BET objects and is a BET object for which a payout is awarded when a bet is made on the win BET object.

In other words, a BET object has a broader concept than a special BET, a base BET and a win BET object. The BET object bet has a broader concept than a special BET and a base BET.

(Display 101)

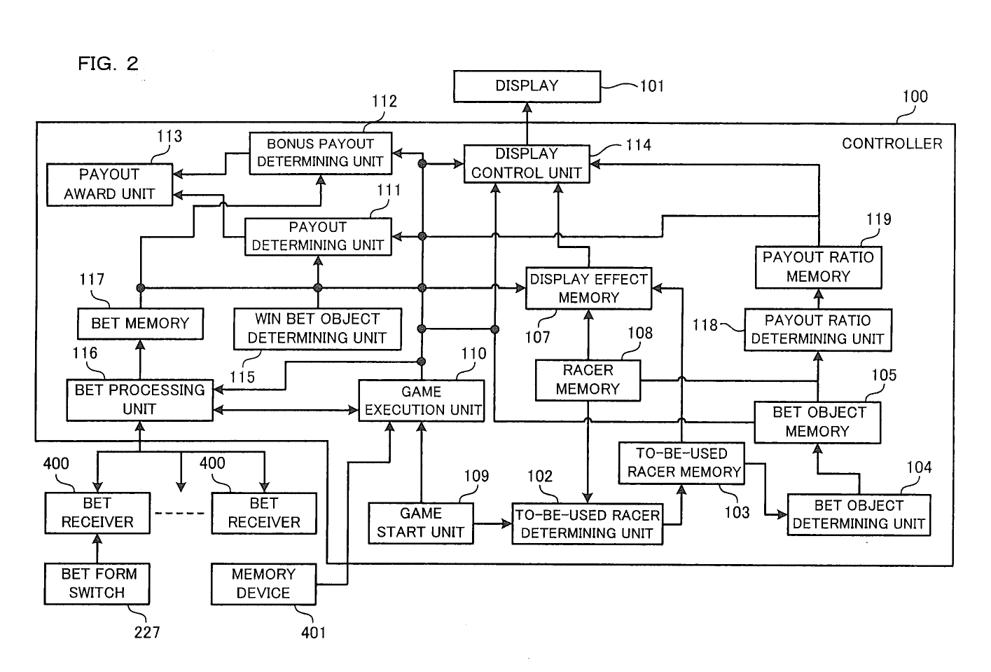

As shown in FIG. 2, a gaming device executing the above playing method includes a display 101, a BET receiver 400 and a controller 100. The display 101 displays an effect about a game and is a part of the BET receiver 400.

The “effect about a game” is an effect displaying: a BET object 170, a payout ratio 175, a bet game value to be displayed when a bet is received by the BET receiver 400;, that a BET object 170 bet is a special BET 172, and that a BET object 170 bet is a base BET 171, as shown in FIG. 1. In addition, it includes effects 180, 181 that are displayed when a bonus payout is determined.

(Controller 100)

The controller 100 is configured to execute:

a first process of, regarding a payout ratio 175 corresponding to a BET object 170, setting a payout ratio 177 for a bet made as a special BET 172 so as to be smaller than a payout ratio 176 for a bet made as a base BET 171;

a second process of controlling a BET receiver 400 to receive a bet of a game value on the BET object 170 from an outside, as the base BET 171, when an operation of betting the game value on the BET object 170 is a base operation, and as the special BET 172, when an operation of betting the game value on the BET object 170 is a special operation;

a third process of determining a win BET object 173 from the BET objects 170, based on an execution result of a game;

a fourth process of, when the win BET object 173 is same as the BET object 170 bet, awarding a payout, based on the payout ratio 175 corresponding to the BET object 170 bet and the game value bet on the BET object 170 bet;

a fifth process of, when the win BET object 173 is same as the BET object 170 bet as the special BET 172, controlling the BET receiver 400 to receive the bet of the game value and controlling the display 101 to display an effect 180 in which a racer intends to acquire a bonus payout;

a sixth process of, when the bet of the game value is received, controlling the display 101 to display an effect 181 in which it is advantageous for the racer to acquire a bonus payout;

a seventh process of randomly determining whether to award a bonus payout, based on whether or not the bet of the game value has been made; and

an eighth process of, when it is determined that the bonus payout is awarded, awarding the bonus payout. In other words, the controller 100 has first to eighth processing units.

In addition, the controller 100 is configured to execute:

a ninth process of controlling the BET receiver 400 to receive a bet of a game value on the BET object 170 from an outside;

a tenth process of, when an input form of a BET form switch 227 capable of accepting at least two forms from an outside is one form, executing a first game program executing a game having a possibility that a bonus payout may be awarded, and when an input form of the switch 227 is an other form, executing a second game program executing a game having no possibility that a bonus payout is awarded;

an eleventh process of determining a win BET object 173 from the BET objects 170, based on an execution result of the first or second game program;

a twelfth process of, when the win BET object 173 is same as the BET object 170 bet, awarding a payout, based on a predetermined condition;

a thirteenth process of, when the second game program is executed and the win BET object 173 is same as the BET object 170 bet, controlling the BET receiver 400 to receive a bet of the game value;

a seventh process of randomly determining whether to award a bonus payout, based on whether or not the bet of the game value has been made; and

an eighth process of, when it is determined that the bonus payout is awarded, awarding the bonus payout. In other words, the controller 100 has seventh to thirteenth processing units.

The controller 100 has a racer memory 108 that stores data about all racers, and a display effect memory 107 that stores the effect data about the racers in the racer memory 108, as effect data for display. The display effect memory 107 is accessible by a display control unit 114. The display control unit 114 reads out the effect data about the racers of the display effect memory 107 based on a control of a game execution unit 110 and display an effect about a game on the display 101. A specific display state will be described later.

Furthermore, the controller 100 has a game start unit 109. The game start unit 109 has a function of outputting a game start signal when a predetermined time period has elapsed after a unit game is over. In addition, the controller 100 has a game execution unit 110 that executes a unit game in which a player is able to bet a game value on a BET object 170, a payout determining unit 111 that determines a payout in a unit game, a bonus payout determining unit 112 that determines a bonus payout in a unit game, and a payout award unit 113 that awards a payout determined in the payout determining unit 111.

Further, the controller 100 has a to-be-used racer determining unit 102 and a to-be-used racer memory 103. The to-be-used racer determining unit 102 determines, from the racers stored in the racer memory 108, a racer that runs (is used) in a race in a unit game, with a game start signal, as trigger, from the game start unit 109. The to-be-used racer memory 103 stores a to-be-used racer that is determined by the to-be-used racer determining unit 102.

Further, the controller 100 has a BET object determining unit 104 and a BET object memory 105. The BET object determining unit 104 determines a BET object 170, from the to-be-used racers that are stored in the to-be-used racer memory 103. The BET object memory 105 stores the BET object 170 determined by the BET object determining unit 104.

Further, the controller 100 has a payout ratio determining unit 118 and a payout ratio memory 119. The payout ratio determining unit 118 determines a payout ratio 175 corresponding to a BET object 170, based on the BET object 170 stored in the BET object memory 105 and the data about the racers stored in the racer memory 108. The payout ratio memory 119 stores the payout ratio 175 corresponding to the BET object 170, which is determined by the payout ratio determining unit 118.

The payout ratio determining unit 118 executes a first process of, regarding a payout ratio 175 corresponding to a BET object 170, setting a payout ratio 177 for a bet made as a special BET 172 so as to be smaller than a payout ratio 176 for a bet made as a base BET 171, with a game start signal, as trigger, from the game start unit 109.

A BET processing unit 116 receives a bet of a game value on the BET object 170 in the BET object memory 105 via the BET receiver 400. The received bet is stored in the BET memory 117. The BET processing unit 116 receives the bet, as a base BET 171, when an operation of betting a game value on the BET object 170 is a base operation, and as a special BET 172, when an operation of betting a game value on the BET object 170 is a special operation. The BET memory 117 stores the BET object 170 bet and the bet game value. In other words, the BET processing unit 116 executes a second process of controlling a BET receiver 400 to receive a bet of a game value on the BET object 170 from an outside, as the base BET 171, when an operation of betting the game value on the BET object 170 is a base operation, and as the special BET 172, when an operation of betting the game value on the BET object 170 is a special operation.

Here, the “base operation” and the “special operation” mean a part of predetermined operations that are performed for the BET receiver 400 so that a player bets a game value on a BET object 170. A part of the predetermined operations is a base operation and another part of the predetermined operations is a special operation. In the mean time, the base operation and the special operation may be a part or all of the predetermined operations.

The game execution unit 110 executes a game, with a game start signal, as trigger, from the game start unit 109.

A win BET object determining unit 115 executes a third process of determining a win BET object 173 from the BET objects 170 stored in the BET object memory 105, based on an execution result of a game that is executed by the game execution unit 110.

The payout determining unit 111 and the payout award unit 113 execute a fourth process of, when the win BET object 173 determined by the execution of the third process is same as the BET object 170 bet, awarding a payout, based on the payout ratio 175 corresponding to the BET object 170 bet and the game value bet on the BET object 170 bet.

The game execution unit 110 executes a fifth process of, when the win BET object 173 is same as the BET object 170 bet as the special BET 172, controlling the BET receiver 400 to receive the bet of the game value and controlling the display 101 to display an effect 180 in which a racer intends to acquire a bonus payout.

The game execution unit 110 executes a sixth process of, when the bet of the game value is received, controlling the display 101 to display an effect 181 in which it is advantageous for the racer to acquire a bonus payout.

The bonus payout determining unit 112 executes a seventh process of randomly determining whether to award a bonus payout, based on whether or not the bet of the game value has been made.

The payout award unit 113 executes an eighth process of, when the bonus payout determining unit 112 determines to award a bonus payout, awarding the bonus payout.

In addition, it can be also said as follows.

As described above, the BET processing unit 116 executes a ninth process of controlling the BET receiver 400 to receive a bet of a game value on the BET object 170 from an outside.

Through the BET form switch 227 serving as the BET receiver 400 at least two forms are inputted from an outside. A memory device 401 stores a first game program that executes a game having a possibility that a bonus payout may be awarded, and a second game program that executes a game having no possibility that a bonus payout is awarded.

The game execution unit 110 executes a tenth process of, when an input form of the BET form switch 227 is one form, executing a first game program executing a game having a possibility that a bonus payout may be awarded, and when an input form of the switch 227 is an other form, executing a second game program executing a game having no possibility that a bonus payout is awarded.

The win BET object determining unit 115 executes an eleventh process of determining a win BET object 173 from the BET objects 170, based on an execution result of the first or second game program.

The payout determining unit 111 and the payout award unit 113 execute a twelfth process of, when the win BET object 173 is same as the BET object 170 bet, awarding a payout, based on a predetermined condition.

The game execution unit 110 executes a thirteenth process of, when the second game program is executed and the win BET object 173 is same as the BET object 170 bet, controlling the BET receiver 400 to receive a bet of a game value.

The bonus payout determining unit 112 executes a seventh process of randomly determining whether to award a bonus payout, based on whether or not the bet of the game value has been made.

The payout award unit 113 executes an eighth process of, when it is determined that a bonus payout is awarded, awarding the bonus payout.

In the mean time, each block of the controller 100 may be structured from a hardware or software, as required.

(Operations of the Controller 100)

With the above structure, an operation of the controller 100 will be described. First, a racer to be used is determined and a BET object is determined based on the determined racer. Based on the information of the racer and the determined BET object, a payout ratio corresponding to the BET object is determined. The payout ratio corresponding to the BET object includes a payout ratio 177 for a bet made as a special BET 172 and a payout ratio 176 for a bet made as a base BET 171. The payout ratio 177 is determined so as to be smaller than the payout ratio 176. Because of this, the controller 100 executes a first process of, regarding a payout ratio 175 corresponding to a BET object 170, setting a payout ratio 177 for a bet made as a special BET 172 so as to be smaller than a payout ratio 176 for a bet made as a base BET 171.

The BET processing unit 116 controls the BET receiver 400 to receive a bet of a game value on the BET object 170. When an operation of betting a game value on the BET object 170, which is performed in the BET receiver 400 by a player, is a base operation, the bet is received as the base BET 171. On the other hand, when an operation of betting a game value on the BET object 170, which is performed in the BET receiver 400 by a player, is a special operation, the bet is received as the special BET 172. Therefore, the controller 100 executes a second process of controlling a BET receiver 400 to receive a bet of a game value on the BET object 170 from an outside, as the base BET 171, when an operation of betting the game value on the BET object 170 is a base operation, and as the special BET 172, when an operation of betting the game value on the BET object 170 is a special operation.

In addition, the win BET object determining unit 115 determines a win BET object 173, from the BET objects 170 stored in the BET object memory 105, based on an execution result of a game that the game execution unit 110 executes. Thereby, the controller 100 executes a third process of determining a win BET object 173 from the BET objects 170 stored in the BET object memory 105, based on an execution result of a game.

The payout determining unit 111 determines a payout award, based on the payout ratio 175 corresponding to the BET object 170 bet and the game value bet on the BET object 170 bet, when the win BET object 173 determined by the execution of the third process is same as the BET object 170 bet. Based on the determination, the payout award unit 113 awards a payout. Therefore, the controller 100 executes a fourth process of, when the win BET object 173 is same as the BET object 170 bet, awarding a payout, based on the payout ratio 175 corresponding to the BET object 170 bet and the game value bet on the BET object 170 bet.

Then, the controller executes a fifth process of, when the win BET object 173 is same as the BET object 170 bet as the special BET 172, controlling the BET receiver 400 to receive the bet of the game value and controlling the display 101 to display an effect 180 in which a racer intends to acquire a bonus payout.

Then, the controller executes a sixth process of, when the bet of the game value is received, controlling the display 101 to display an effect 181 in which it is advantageous for the racer to acquire a bonus payout.

Then, the controller executes a seventh process of randomly determining whether to award a bonus payout, based on whether or not the bet of the game value has been made.

Then, the controller executes an eighth process of, when it is determined that a bonus payout is awarded, awarding the bonus payout.

As clearly seen from the above operations, the gaming device 10 realizes a playing method including the steps of: regarding a payout ratio 175 corresponding to a BET object 170, setting a payout ratio 177 for a bet made as a special BET 172 so as to be smaller than a payout ratio 176 for a bet made as a base BET 171;

controlling a BET receiver 400 to receive a bet of a game value on the BET object 170 from an outside, as the base BET 171, when an operation of betting the game value on the BET object 170 is a base operation, and as the special BET 172, when an operation of betting the game value on the BET object 170 is a special operation;

determining a win BET object 173 from the BET objects 170, based on an execution result of a game;

when the win BET object 173 is same as the BET object 170 bet, awarding a payout, based on the payout ratio 175 corresponding to the BET object 170 bet and the game value bet on the BET object 170 bet;

when the win BET object 173 is same as the BET object 170 bet as the special BET 172, controlling the BET receiver 400 to receive the bet of the game value and controlling the display 101 to display an effect 180 in which a racer intends to acquire a bonus payout;

when the bet of the game value is received, controlling the display 101 to display an effect 181 in which it is advantageous for the racer to acquire a bonus payout;

randomly determining whether to award a bonus payout, based on whether or not the bet of the game value has been made; and

when it is determined that the bonus payout is awarded, awarding the bonus payout.

According to the playing method, a payout ratio 177 corresponding to a BET object 170 on which a bet is made as a special BET 172 is set so as to be smaller than a payout ratio 176 corresponding to a BET object 170 on which a bet is made as a base BET 171. The BET receiver 400 is controlled to receive a bet of the game value on a BET object 170 from an outside, as a base BET 171, when an operation of betting the game value on the BET object 170 is a base operation, and as a special BET 172, when an operation of betting the game value on the BET object 170 is a special operation. Based on an execution result of a game, a win BET object 173 is determined from the BET objects 170. When the win BET object 173 is same as the BET object 170 bet, the BET receiver 400 is controlled to receive the bet of the game value and an effect 180 in which a racer intends to acquire a bonus payout is displayed on the display 110. When a bet of the game value is received, an effect 181 in which it is advantageous for the racer to acquire a bonus payout is displayed on the display 101. Based on whether or not the bet of the game value has been made, it is randomly determined whether to award a bonus payout. When it is determined that a bonus payout is awarded, the bonus payout is awarded.

Accordingly, a game can be provided in which by making a bet on a BET object as a special BET, an award of a bonus payout may be determined although a payout ratio of the special BET is smaller than a payout ratio of the base BET. Therefore, it is possible to give a player an expectation that a bonus payout may be awarded, in addition to the characteristics of a conventional game, without deteriorating the conventional game characteristic.

Furthermore, the bonus payout is determined on the basis of whether or not the bet of game value is made, this encourages a player to bet a game value for the bonus payout.

Furthermore, an effect in which a racer intends to acquire a bonus payout and an effect in which it is advantageous for the racer to acquire the bonus payout are displayed on the display, This encourages a player to bet a game value. In addition, this may cause the player to feel a strong attachment to the racer.

Further, by setting a payout ratio of the special BET to be smaller than a payout ratio of the base BET, a payout corresponding to a difference between the payout ratio of the base BET and the payout ratio of the special BET can be provided as a bonus payout. Therefore, this may decrease the possibility that the earnings of a game arcade are reduced due to an award of a bonus payout.

Further, a payout ratio of the special BET is smaller than a payout ratio of the base BET and a bonus award is determined on the basis of whether or not a bet of a game value has been made. This may encourage a player, who wants to acquire a payout based on a payout ratio of a base BET, to bet a game value.

In addition, the operations of the controller 100 are also explained as follows. The BET processing unit 116 controls the BET receiver 400 to receive a bet of a game value on a BET object 170 from an outside. Thereby, the controller 100 executes a ninth process of controlling the BET receiver 400 to receive a bet of a game value on the BET object 170 from an outside.

The game execution unit 110 executes a first game program executing a game having a possibility that a bonus payout may be awarded, when an input form of the BET form switch 227 is one form, and executes a second game program executing a game having no possibility that a bonus payout is awarded, when an input form of the BET form switch 227 is an other form. Thereby, the controller 100 executes a tenth process of, when an input form of a BET form switch 227 capable of accepting at least two forms from an outside is one form, executing a first game program executing a game having a possibility that a bonus payout may be awarded, and when an input form of the switch 227 is an other form, executing a second game program executing a game having no possibility that a bonus payout is awarded.

The win BET object determining unit 115 determines a win BET object 173 from the BET objects 170, based on an execution result of the first or second game program. Thereby, the controller 100 executes an eleventh process of determining a win BET object 173 from the BET objects 170, based on an execution result of the first or second game program.

By executing the above fourth process, the controller 100 executes a twelfth process of, when the win BET object 173 is same as the BET object 170 bet, awarding a payout, based on a predetermined condition.

The win BET object determining unit 115 determines a win BET object 173 from the BET objects 170, based on an execution result of the first or second game program. Thereby, the controller 100 executes a thirteenth process of, when the second game program is executed and the win BET object 173 is same as the BET object 170 bet, controlling the BET receiver 400 to receive a bet of a game value.

The payout determining unit 111 and the payout award unit 113 award a payout, when the win BET object 173 is same as the BET object 170 bet, based on a predetermined condition. Thereby, the controller 100 executes a seventh process of randomly determining whether to award a bonus payout, based on whether or not the bet of the game value has been made.

The payout award unit 113 awards a bonus payout when it is determined that a bonus payout is awarded. Thereby, the controller 100 executes an eighth process of, when it is determined that a bonus payout is awarded, awarding the bonus payout.

As clearly seen from the above operations, the gaming device 10 realizes a playing method including the steps of:

controlling a BET receiver 400 to receive a bet of the game value on a BET object 170 from an outside;

when an input form of a BET form switch 227 capable of accepting at least two forms from an outside is one form, executing a first game program that executes a game in which a bonus payout may be awarded, and when an input form of the switch 227 is an other form, executing a second game program that executes a game in which a bonus payout is not awarded;

determining a win BET object 173 from the BET objects 170, based on an execution result of the first or second game program;

when the win BET object 173 is same as the BET object 170 bet, awarding a payout, based on a predetermined condition;

when the second game program is executed and the win BET object 173 is same as the BET object 170 bet, controlling the BET receiver 400 to receive a bet of the game value;

randomly determining whether to award a bonus payout, based on whether or not the bet of the game value has been made; and

when it is determined that the bonus payout is awarded, awarding the bonus payout.

According to the playing method, the BET receiver 400 is controlled to receive a bet of the game value on a BET object 170 from an outside. When an input form of the BET form switch 227 is one form, a first game program stored in a memory device 401 is executed. On the other hand, when an input form of the BET form switch 227 is an other form, a second game program stored in the memory device 401 is executed. Based on an execution result of the first or second game program, a win BET object 173 is determined from the BET objects 170. When the win BET object 173 is same as the BET object 170 bet, a payout is awarded, based on a predetermined condition. When the second game program is executed and the win BET object 173 is same as the BET object 170 bet, it is randomly determined whether to award a bonus payout. When it is determined that the bonus payout is awarded, the bonus payout is awarded.

Accordingly, when a player changes an input form of the BET form switch 227 to one form, a game is executed having a possibility that a bonus payout may be awarded. When a player changes an input form of the BET form switch to an other form, a game is executed having no possibility that a bonus payout is awarded. Therefore, it is possible to give a player an expectation that a bonus payout may be awarded, in addition to the characteristics of a conventional game, without deteriorating the conventional game characteristic.

(Display State of the Display 101)

Hereinafter specifically described is an example of a display state of the display 101 in the operation processes of the gaming device 10 and the playing method.

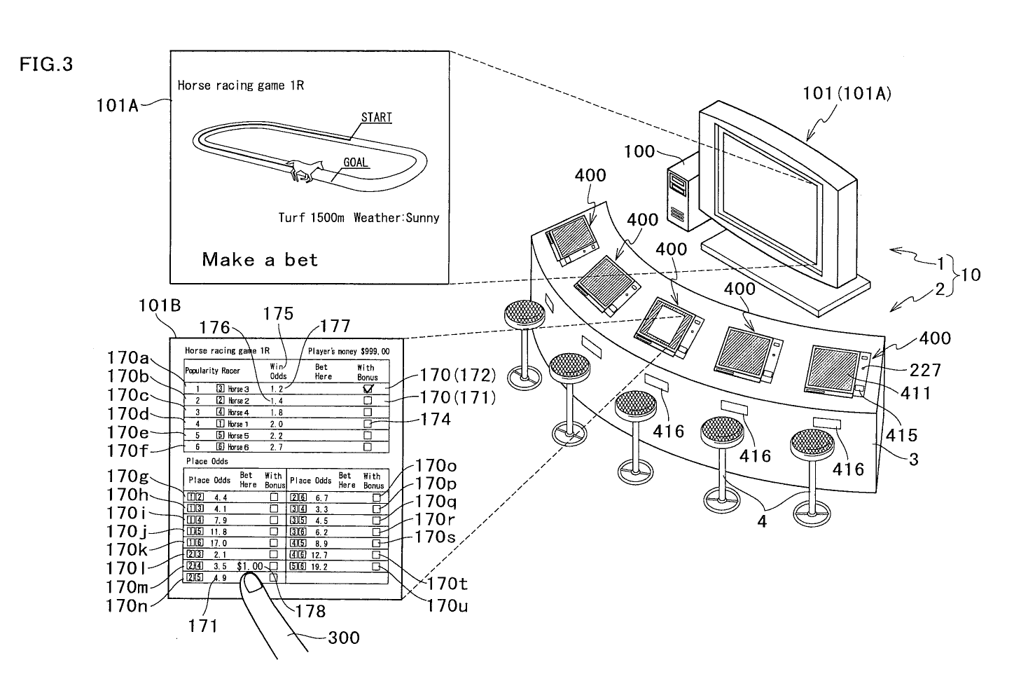

The display 101 displays an effect about a game and constitutes a part of the BET receiver 400. As shown in FIG. 3, the display 101 includes a display 101A that displays an effect about a game, and a display 101B of the BET receiver 400. The display 101B is a part of the BET receiver 400 and as shown in FIG. 3, it displays a BET object 170, a BET object 170 bet as a base BET 171, a BET object 170 bet as a special BET 172, a game value 178 bet on the BET object 170, an identifier 174 indicating whether the BET object 170 is a base BET 171 or a special BET 172, and an effect about a game. A touch panel 226 is provided at a front of the display 101B. A player pushes the touch panel 226 with a finger 300 and the like, thereby betting a game value on the BET object 170.

In the followings, a display state of the display 101B, which is a part of the BET receiver 400, will be described.

As shown in FIG. 3, the display 101B displays several BET objects 170. To be more specific, the display 101B displays “No. 3 horse 3” 170a, “No. 2 horse 2” 170b, “No. 4 horse 4” 170c, “No. 1 horse 1” 170d, “No. 5 horse 5” 170e, “No. 6 horse 6” 170f, “a combination of 1 and 2” 170g, “a combination of 1 and 3” 170h, “a combination of 1 and 4” 170i, “a combination of 1 and 5” 170j, “a combination of 1 and 6” 170k, “a combination of 2 and 3” 170l, “a combination of 2 and 4” 170m, “a combination of 2 and 5” 170n, “a combination of 2 and 6” 170o, “a combination of 3 and 4” 170p, “a combination of 3 and 5” 170q, “a combination of 3 and 6” 170r, “a combination of 4 and 5” 170s, “a combination of 4 and 6” 170t and “a combination of 5 and 6” 170u. In the mean time, the BET objects 170 that are displayed by the display 101B are not limited thereto.

In addition, as shown in FIG. 3, the display 101B displays the payout ratios 175 corresponding to the BET objects 170. To be more specific, the payout ratios 175a to 175u respectively corresponding to the respective BET objects 170a to 170u are “1.2”, “1.4”, “1.8”, “2.0”, “2.2”, “2.7”, “4.4”, “4.1”, “7.9”, “11.8”, “17.0”, “2.1”, “3.5”, “4.9”, “6.7”, “3.3”, “4.5”, “6.2”, “8.9”, “12.7” and “19.2”. Like this, there is at least one payout ratio 175 corresponding to one BET object 170. In the mean time, the payout ratios 175 are not limited thereto.

In addition, as shown in FIG. 3, the display 101B displays a game value 178 that is bet on the BET object 170. To be more specific, the display 101B displays that the game values 178 bet on the BET objects 170a and 170m are $1.00. In addition, the display 101B displays an identifier 174 indicating whether a BET object 170 is a base BET 171 or a special BET 172. To be more specific, a BET object 170 having an identifier 174 with a check mark indicates that a bet is to be made (or has been made) as a special BET 172. To the contrary, a BET object having an identifier 174 without a check mark indicates that a bet is to be made (or has been made) as a base BET 171. Note that the identifier indicating whether a BET object is a base BET or a special BET is not limited thereto.

(Relation Between Proceedings of a Game and a Display State of the Display 101)

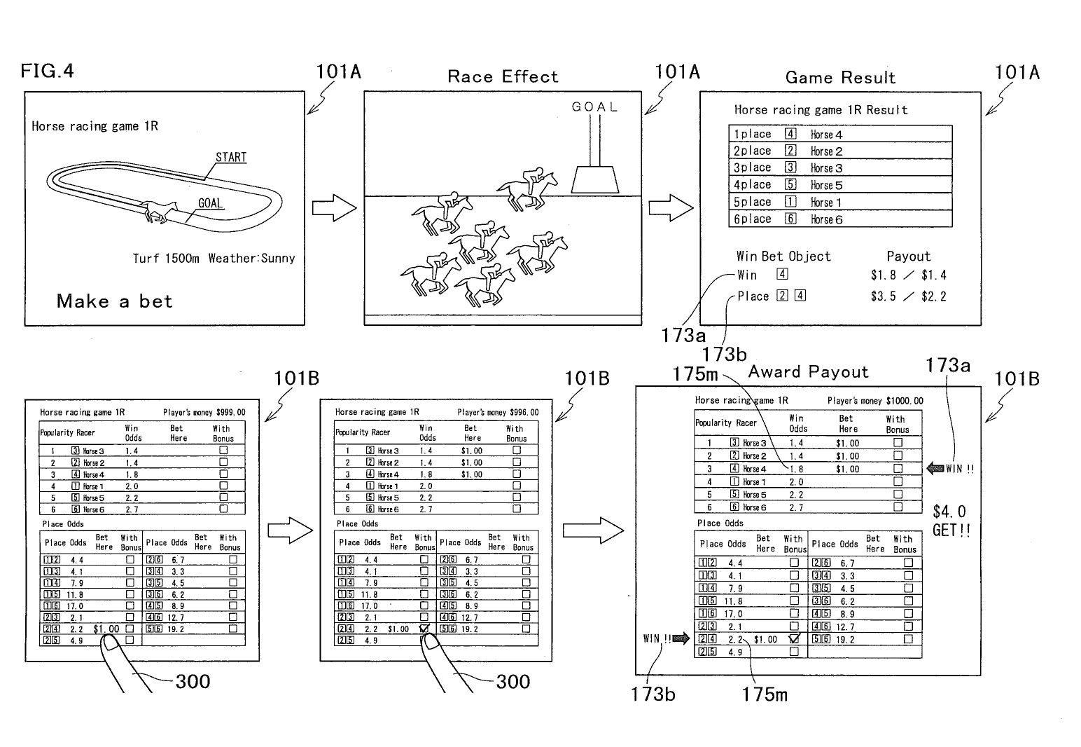

Next, a relation between proceedings of a game and a display state of the display 101 will be described with reference to FIG. 4.

Receiving a game start signal from the game start unit 109, a to-be-used racer is determined, a BET object 170 is determined and a payout ratio 175 is determined, the game execution unit 110 controls the display 101A to display an effect image 182 that is shown in a top-left of FIG. 4, and controls the display 101B to display a BET image that is shown in a bottom-left of FIG. 4, while controlling the BET receiver 400 to receive a bet of a game value on the BET object 170 from an outside.

An operation of betting a game value on the BET object 170 will be described. For example, when a player wants to bet game value of $1.00 on a BET object 170m, as a special BET 172, the player pushes a portion where the row of the BET object 170m intersects the column of “BET here” in the touch panel 226 with a finger 300 and selects an amount of a game value ($1.00), thereby making a bet, as shown in a bottom-left of FIG. 4. Then, as shown in a bottom-middle of FIG. 4, when the player pushes a portion where the row of the BET object 170m intersects the column of “With Bonus” in the touch panel 226, a check mark is indicated on the identifier 174. With such operation, the bet can be made as a special BET 172. This operation is a special operation. In the mean time, when the operation for the “With Bonus” column is omitted, the game value is bet as a base BET 171.

As shown in a bottom-left and a bottom-middle of FIG. 4, a payout ratio 177 for a bet made on the BET object 170m as a special BET 172 is “2.2” and a payout ratio 176 for a bet made on the same BET object 170m as a base BET 171 is “3.5”. Therefore, the payout ratio 177 for a bet made on the BET object 170m as a special BET 172 is set to be smaller than the payout ratio 176 for a bet made on the BET object 170m as a base BET 171.

In the above, the game value is bet and then the “With Bonus” column is operated. However, the invention is not limited thereto. For example, a reverse operation thereof may be possible, or alternatively, the two operations may be made at the same time. In addition, although the payout ratio 177 is set to be smaller than the payout ratio 176, the payout ratio 177 may be set to be larger than the payout ratio 176.

In addition, the touch panel 226 is pushed to bet a game value on a BET object. However, the present invention is not limited thereto.

In addition, the BET receiver 400 is provided with a BET form switch 227. The BET form switch 227 is structured in such a manner that when the BET form switch 227 in one form is pushed and then released, the form of the BET form switch 227 transitions to an other form, and when the BET form switch 227 in the other form is pushed and then released, the form of the BET form switch 227 transitions to the one form. In a state that the BET form switch 227 provided on the BET receiver 400 is pushed in so that the protruded height thereof is a predetermined height or less (one form), when a game value is bet, the bet is made as a special BET 172. This is a special operation. On the other hand, in a state that the BET form switch 227 is not pushed in so that the protrusion height thereof is higher than a predetermined height, when a game value is bet, the bet is made as a base BET 171. This is a base operation. Meantime, in this embodiment, the BET form switch 227 has two forms that is one form and the other form. However, the present invention is not limited thereto. For example, two or more forms are possible.

Therefore, when a player sets an input form of the switch as one form, a game having a possibility that a bonus payout may be awarded is executed. When a player sets an input form of the switch as an other form, a game having no possibility that a bonus payout is awarded is executed. Accordingly, it is possible to give a player an expectation that a bonus payout may be awarded, in addition to the characteristics of a conventional game, without deteriorating the conventional game characteristic.

When a predetermined time has elapsed after the BET receiver 400 starts to receive a bet, the game execution unit 110 controls the receiver to stop receiving of the bet and controls the display 101A to display a race effect, as shown in a top-middle of FIG. 4. When a win BET object 173 is determined from the BET objects 170, the game execution unit 110 controls the display 101A to display a race practice based on the determined win BET object 173. After that, as shown in a top-right of FIG. 4, an effect about a result of the game is displayed on the display 101A. The determined win BET object 173 is displayed.

To be more specific, since a racer No. 4 takes first place and a racer No. 2 takes second place, the determined win BET objects 173 are a win BET object 173a, which is the BET object 170c, and a win BET object 173b, which is the BET object 170m.

The display 101A displays an effect about a result of the game and simultaneously the display 101B displays the win BET objects 173, as shown in a bottom-right of FIG. 4. In addition, when there is a BET object 170 that is a win BET object 173 among the BET objects 170 on which a player makes a bet, a payout is awarded, based on the payout ratio 175 corresponding to the BET object 170 bet and the game value bet on the BET object 170.

Specifically, as shown in a bottom-right of FIG. 4, the BET objects 170 bet are the BET objects 170a to 170c and 170m (four BET objects). The game value bet on each of the BET objects is $1.00. The BET objects 170a to 170c are bet as a base BET 171 and the BET object 170m is bet as a special BET 172. Then, based on the payout ratio 175c of “1.8” corresponding to the BET object 170c that is the win BET object 173a and the game value of $1.00 that is bet on the BET object 170c, it is determined that a payout to be awarded is $1.8. In addition, based on the payout ratio 175m of “2.2” corresponding to the BET object 170m that is the win BET object 173m and the game value of $1.00 that is bet on the BET object 170m, it is determined that a payout to be awarded is $2.2. Therefore, a total $4.0 is awarded as a payout.

In the mean time, “1.8” of the payout ratio 175c is the payout ratio 176c corresponding to the BET object 170c as a base BET 171 and “2.2” of the payout ratio 175m is the payout ratio 177m corresponding to the BET object 170m as a special BET 172. In other words, the payout ratio 175 corresponding to the BET object 170 has a broader concept than the payout ratio 176 corresponding to the BET object 170 as a base BET 171 and the payout ratio 177 corresponding to the BET object 170 as a special BET 172.

In addition, in this embodiment, the payout is awarded, based on the payout ratio 175 and the game value bet. However, the present invention is not limited thereto. For example, a payout to be awarded may be a predetermined payout.

In addition, in this embodiment, the contents are displayed in the above-mentioned manner. However, the present invention is not limited thereto.

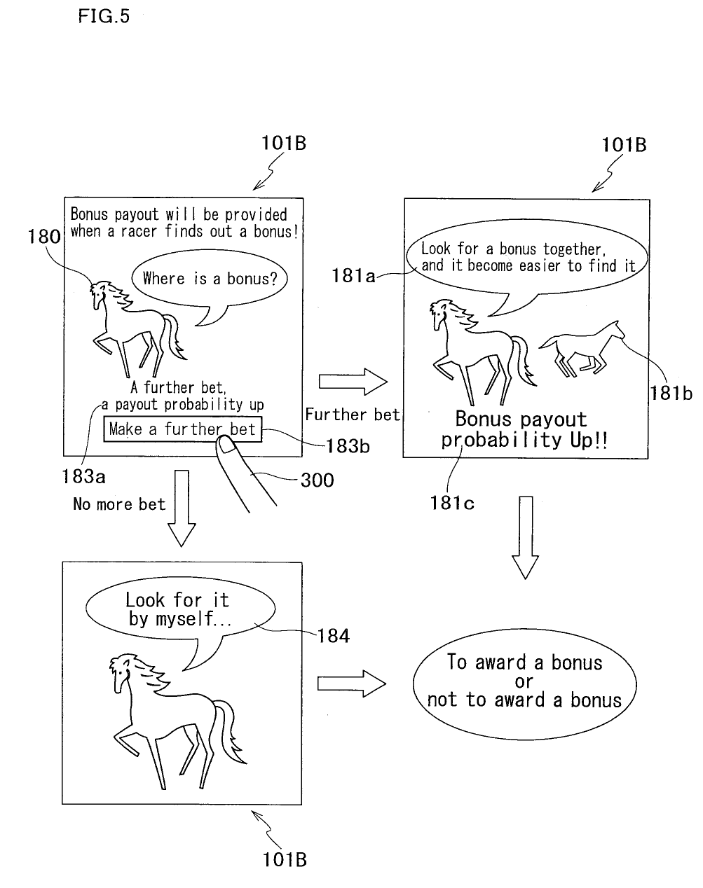

Next, a bonus payout effect that is displayed on the display 101B will be described. Based on a result of a game, a win BET object 173 is determined. When the determined win BET object 173 is same as the BET object 170 bet as a special BET 172, the display 101B displays a bonus payout effect, as shown in a top-left of FIG. 5. As shown in a top-left of FIG. 5, the bonus payout effect is an effect 180 in which a racer intends to acquire a bonus payout. To be more specific, the display 101B displays an image showing that a racer who has taken a first place says “Where is a bonus?” and an image showing a message of “Bonus payout will be provided when a racer finds out a bonus!”.

In addition, the display 101B displays an image 183a showing a message of “A further bet, a payout probability up” and an image 183b of in a form of a button having a message of “Make a further bet”. When a player pushes the touch panel 226 of the button-form image 183b showing the message of “Make a further bet”, a predetermined game value is bet. In other words, the BET receiver 400 is under a state that it receives a bet of a game value.

Here, when a player pushes, in the touch panel 226, the button-form image 183b showing the message of “Make a further bet”, i.e., when a bet of a game value is received, an effect 181 showing that it is advantageous for a racer to acquire a bonus payout is displayed on the display 101B. To be more specific, as shown in a top-right of FIG. 5, an image 181a showing a message of “Look for a bonus together, and it become easier to find it”, an image showing several racers, and an image 181c showing a message of “Bonus payout probability Up!” are displayed.

In the mean time, when, in the touch panel 226, the button-form image 183b showing a message of “Make a further bet” is not pushed in a predetermined time, i.e., a bet of a game value is not received in a predetermined time, a predetermined effect is performed. To be more specific, as shown in a bottom-left of FIG. 5, an image 184 showing a message of “Look for it by myself” is displayed on the display 101B.

Then, as shown in a bottom-right of FIG. 5, an effect showing that a bonus payout is awarded, or an effect showing that a bonus payout is not awarded is displayed on the display 101B.

In the mean time, in this embodiment, the button-form image of “Make a further bet” is displayed and the game value is bet by the operating the touch panel 226. However, the present invention is not limited thereto. For example, a bet may be made by operating a switch and the like.

(Mechanical Structure: Gaming Machine Main Body 1)

Next, described is an example of the gaming device 10 structured in a mechanical and electrical manner.

As shown in FIG. 3, the gaming device 10 is provided in a game arcade. The gaming device 10 executes a unit game using a game medium which is a game value. The game medium is a coin, bill or electronic negotiable information corresponding to them. Meanwhile, in the present invention, the game medium is not particularly limited. For example, a medal, token, electronic money, ticket and the like can be used. The ticket is not particularly limited and may be a ticket with a barcode which will be described later.

As shown in FIG. 3, the gaming device 10 has a gaming machine main body 1 and a gaming machine terminal 2. The gaming machine main body 1 includes the controller 100 having a calculation device, memory device and the like and the display 101A controlled by the controller 100, such as liquid crystal display. The display 101A is large-sized so as to be seen by many players around it. The display 101A displays a variety of information about a game, an effect image about a game and the like.

(Mechanical Structure: Gaming Machine Terminal 2)

A gaming machine terminal 2 is disposed in front of the display 101A. The gaming machine terminal 2 has a cabinet 3, a number of terminal devices 400 provided to the cabinet 3 and a number of chairs 4 disposed in the vicinity of the cabinet 3. The cabinet 3 is fan-shaped around the display 101. The terminal devices 400 are disposed at an equal interval on the top face of the cabinet 3. In addition, coin trays 416 are disposed at a side of the cabinet 3.

The terminal device 400 as the BET receiver 400 has a liquid crystal display device that forms the display 101B, an operation panel 415, a coin tray 416 and a touch panel 226. The operation panel 415 has a coin receiving slot, a bill validator and a BET form switch 227. A control panel 220 is provided with a variety of buttons. The buttons allow a player to input instructions related to a game. The coin receiving slot allows the reception of a coin into the cabinet 3.

The operation panel 415 has a change button and a cashout button. The change button is a button to be used when a player asks a staff in the game arcade for exchange of money. The cashout button is a button used for inputting an instruction to pay out the coins of total credit-number into the coin tray 416.

The bill validator validates whether a bill is genuine or not and receives the genuine bill into the terminal device 400. In addition, the bill validator is capable of reading a ticket having a barcode attached thereto. When the bill validator reads the ticket having a barcode, it outputs a reading signal regarding the content read.

Furthermore, the operation panel 415 is provided with a ticket printer, a card reader, a data indicator and a keypad. The ticket printer prints a barcode having data encoded thereto, such as credit-number, date and time, identification number of the gaming device 10 and the like, onto a ticket, then outputting the ticket having the barcode attached thereto. A player can play a game in another gaming device using the ticket having a barcode and exchange the ticket having a barcode with a bill or the like in a change booth of the game arcade.

The card reader reads and writes the data from and into a smart card. The smart card is a card carried by a player, into which data for identifying the player and data relating to a game history of the player are memorized.

The data indicator is structured from a fluorescent display and the like, and displays the data read by the card reader and the data inputted by the player through the keypad. Through the keypad, instructions or data relating to a ticket issue or the like is inputted.

A belly glass is provided around the operation panel 415 or to a side of the gaming machine terminal 2. A character of the gaming device 10 and the like are drawn on the belly glass. In addition, the terminal device 400 is configured to display an image representative of an effect image, introduction of game contents and explanation of game rules. Furthermore, the cabinet 3 is provided with a speaker for voice output.

The light-transmissive touch panel 226 is provided to a front of the display 101B. The touch panel 226 is structured in such a manner that signal lines are arranged in horizontal (X) and vertical (Y) directions thereby arranging switch parts in a matrix. As shown in FIGS. 1 and 3 to 5, when the touch panel 226 is pushed with a finger 300 and the like from the front thereof, two dimensional position data consisting of X and Y directions of a switch part that is contacted due to the push is outputted as a touch panel signal, so that the pushed position can be determined.

The BET form switch 227 is a switch of which state can transition between a state in which a main body of the switch is pushed in so that the protrusion height thereof is a predetermined height or less (one form) and another state in which a main body of the switch is not pushed in so that the protrusion height thereof is higher than a predetermined height (an other form). The BET form switch 227 outputs a signal indicating the switch is in one form, and a signal indicating the switch is in the other form. The BET form switch 227 is operated in such a manner that when the BET form switch 227 in one form is pushed and then released, the form of the BET form switch 227 transitions to the other form, and when the BET form switch 227 in the other form is pushed and then released, the form of the BET form switch 227 transitions to the one form. That is, the BET form switch 227 is capable of accepting at least two forms to be inputted from an outside.

(Electric Structure: Gaming Machine Main Body 1)

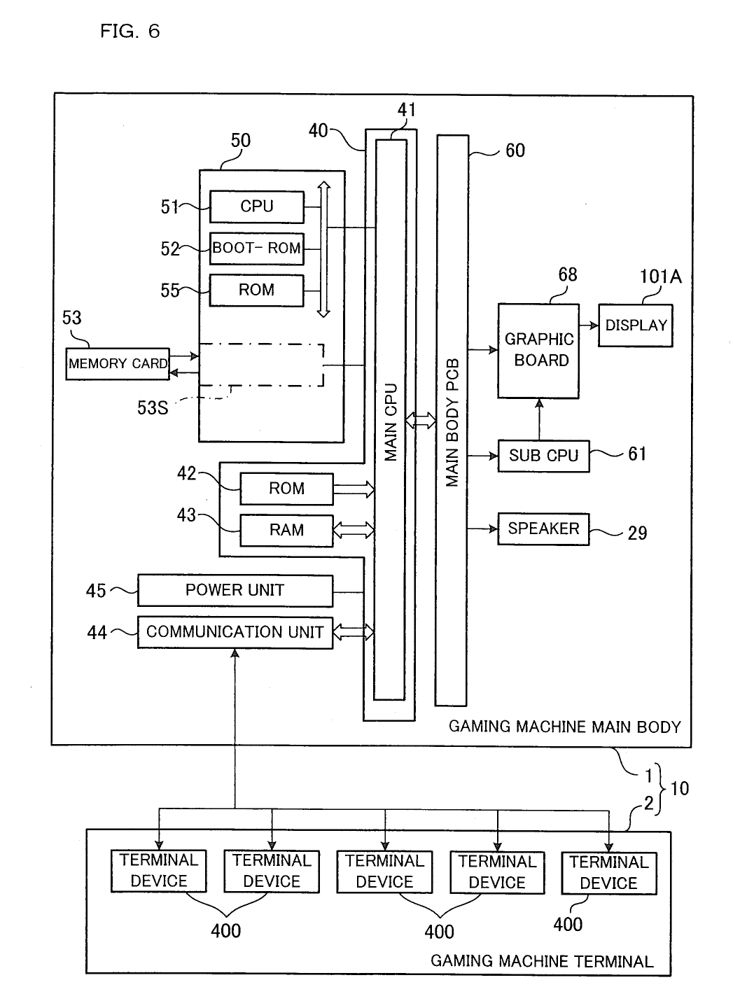

A control unit in FIG. 6 is mounted in the controller 100 of the gaming machine main body 1. The control unit includes a motherboard 40, a main body PCB (Printed Circuit Board) 60, a gaming board 50, a sub CPU 61, various switches, and a speaker 29.

The gaming board 50 is provided with a CPU (Central Processing Unit) 51, a ROM 55 and a boot ROM 52 which are connected to each other by an internal bus and a card slot 53S corresponding to a memory card 53.

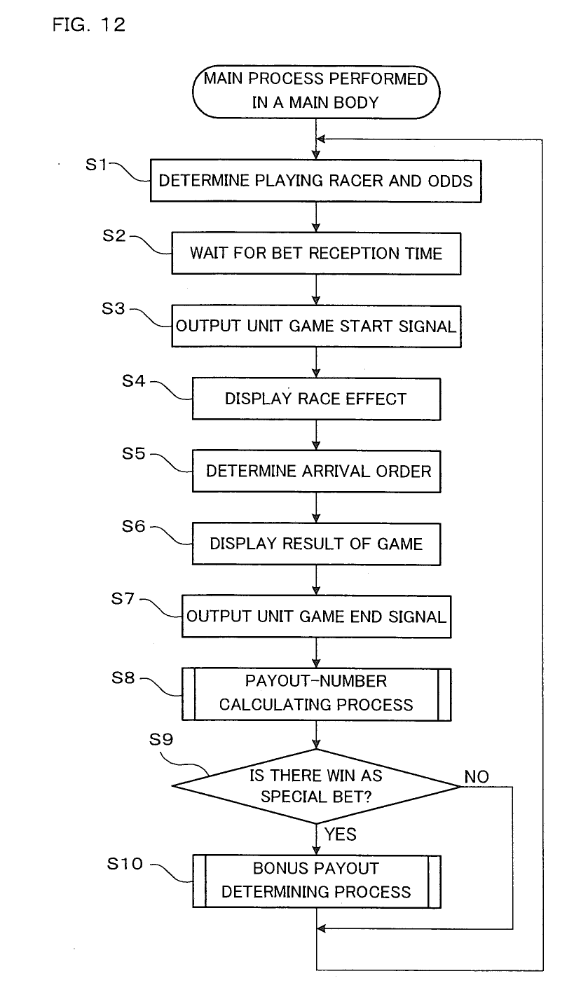

The memory card 53, serving as a memory device 401, stores a game program and a gaming system program. To be more specific, it stores a first game program executing the game having a possibility that a bonus payout may be awarded and a second game program executing the game having no possibility that a bonus payout is awarded. The details of the first game program and the second game program are described in FIG. 12.

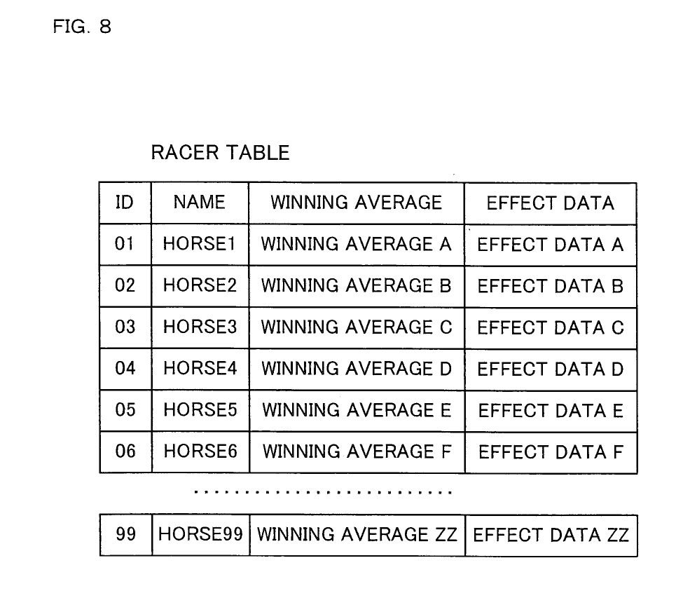

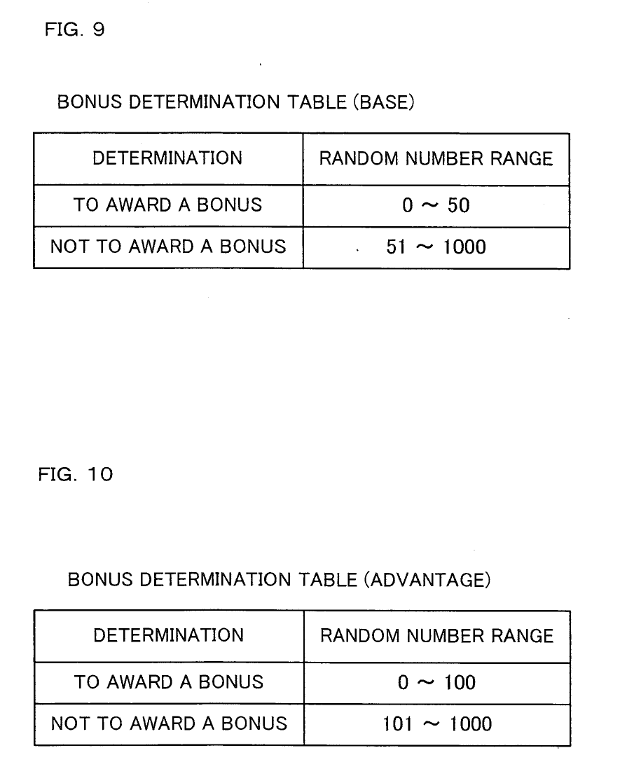

In addition, the memory card 53 stores a variety of data that are used in the game program and the gaming system program. To be more specific, the information data about each racer is stored in a racer table form shown in FIG. 8. The data in the racer table of FIG. 8 are used for an effect of a race game, a determination of a BET object 170, a determination of a payout ratio 175 and the like. Furthermore, the data indicating a relation of whether to award a bonus payout and a range of random numbers is stored in a form of a bonus determination table shown in FIGS. 9 and 10. The data in the bonus determination tables of FIGS. 9 and 10 are used to determine whether to determine a bonus payout. Each data table will be specifically described later. In the mean time, these data are transmitted to a RAM 43 of a motherboard 40 when executing the game program.

In addition, the card slot 53S is structured so that the memory card 53 can be inserted and removed, and connected to the motherboard 40 through an IDE bus. Accordingly, it is possible to change a type or content of a game to be executed in the gaming device 10, by removing the memory card 53 from the card slot 53S, writing another game program and game system program in the memory card 53 and inserting the memory card 53 into the card slot 53S.

The game program includes a program relating to a game progress and a program for shifting a gaming state into a bonus payout effect. In addition, the game program includes image data and voice data to be outputted during the game.

The CPU 51, the ROM 55 and the boot ROM 52, which are connected to each other by the internal bus, are connected to the motherboard 40 through the PCI bus. The PCI bus transfers a signal between the motherboard 40 and the gaming board 50 and supplies power to the gaming board 50 from the motherboard 40. The ROM 55 stores nation identification information and an authentication program. The boot ROM 52 stores a preliminary authentication program and a program (boot code) for the CPU 51 to start the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication to be authenticated is not falsified, i.e., for authenticating the authentication program.

The motherboard 40 has a main CPU 41 (controller), a ROM (Read Only Memory) 42 and a RAM (Random Access Memory) 43. The main CPU 41 has functions as a controller for controlling the whole gaming device 10. In particular, after a unit game is over and then a predetermined time period has elapsed the main CPU 41 controls the BET receiver 400 to receive a bet from an outside and perform a control for determining a BET object 170 and a payout ratio 175 thereof.

In other words, the main CPU 41 has the functions of the controller 100 that executes a process of, regarding a payout ratio 175 corresponding to a BET object 170, setting a payout ratio 177 for a bet made as a special BET 172 so as to be smaller than a payout ratio 176 for a bet made as a base BET 171; a process of controlling a BET receiver 400 to receive a bet of a game value on the BET object 170 from an outside, as the base BET 171, when an operation of betting the game value on the BET object 170 is a base operation, and as the special BET 172, when an operation of betting the game value on the BET object 170 is a special operation; a process of determining a win BET object 173 from the BET objects 170, based on an execution result of a game; a process of, when the win BET object 173 is same as the BET object 170 bet, awarding a payout, based on the payout ratio 175 corresponding to the BET object 170 bet and the game value bet on the BET object 170 bet; a process of, when the win BET object 173 is same as the BET object 170 bet as the special BET 172, controlling the BET receiver 400 to receive the bet of the game value and controlling the display 101 to display an effect 180 in which a racer intends to acquire a bonus payout; a process of, when the bet of the game value is received, controlling the display 101 to display an effect 181 in which it is advantageous for the racer to acquire a bonus payout; a process of randomly determining whether to award a bonus payout, based on whether or not the bet of the game value has been made; and a process of, when it is determined that the bonus payout is awarded, awarding the bonus payout.

In addition, the main CPU 41 has the functions of the controller 100 that executes a process of controlling a BET receiver 400 to receive a bet of the game value on a BET object 170 from an outside; a process of when an input form of a BET form switch 227 capable of accepting at least two forms from an outside is one form, executing a first game program that executes a game in which a bonus payout may be awarded, and when an input form of the switch 227 is an other form, executing a second game program that executes a game in which a bonus payout is not awarded; a process of determining a win BET object 173 from the BET objects 170, based on an execution result of the first or second game program; a process of when the win BET object 173 is same as the BET object 170 bet, awarding a payout, based on a predetermined condition; a process of when the second game program is executed and the win BET object 173 is same as the BET object 170 bet, controlling the BET receiver 400 to receive a bet of the game value; a process of randomly determining whether to award a bonus payout, based on whether or not the bet of the game value has been made; and a process of when it is determined that the bonus payout is awarded, awarding the bonus payout.

The ROM 42 stores a program such as BIOS (Basic Input/Output System) executed by the main CPU 41, and data used permanently. When the BIOS is executed by the main CPU 41, each of peripheral devices is initialized and the game program and the game system program stored in the memory card 53 are read out through the gaming board 50.

The RAM 43 stores the data or program that is used when the main CPU 41 carries out a process. For example, in the RAM 43, a to-be-used racer memory 103, a BET object memory 105, a payout ratio memory 119, a display effect memory 107 and a BET memory 117 are formed in a form of a data area, respectively. The data area of the to-be-used racer memory 103 stores data indicating a to-be-used racer. The data area of the BET object memory 105 stores data indicating a BET object 170. The data area of the payout ratio memory 119 stores data indicating a payout ratio 175. The data area of the display effect memory 107 stores effect data to be displayed. The data area of the BET memory 117 stores data about a bet, such as a BET object 170 or game value bet, terminal information and the like.

The motherboard 40 is connected to a communication unit 44. The communication unit 44 is provided to communicate with the terminal devices 400, a host computer mounted in the game arcade and the like through a communication line. Further, the motherboard 40 is connected to a power unit 45. When power is supplied to the motherboard 40 from the power unit 45, the main CPU 41 of the motherboard 40 is started up, and the power is supplied to the gaming board 50 through the PCI bus, so that the CPU 51 is also started up.

The motherboard 40 is connected to a main body PCB 60 through a signal bus. The main body PCB 60 is connected to a graphic board 68 and a speaker 29.

The graphic board 68 controls an image display on the display 101A, based on a control signal outputted from the main CPU 41. In addition, the graphic board 68 includes a VDP that generates image data based on a control signal outputted from the main CPU 41, a video RAM that temporarily stores the image data generated by the VDP.

(Electric Structure: Gaming Machine Terminal 2)

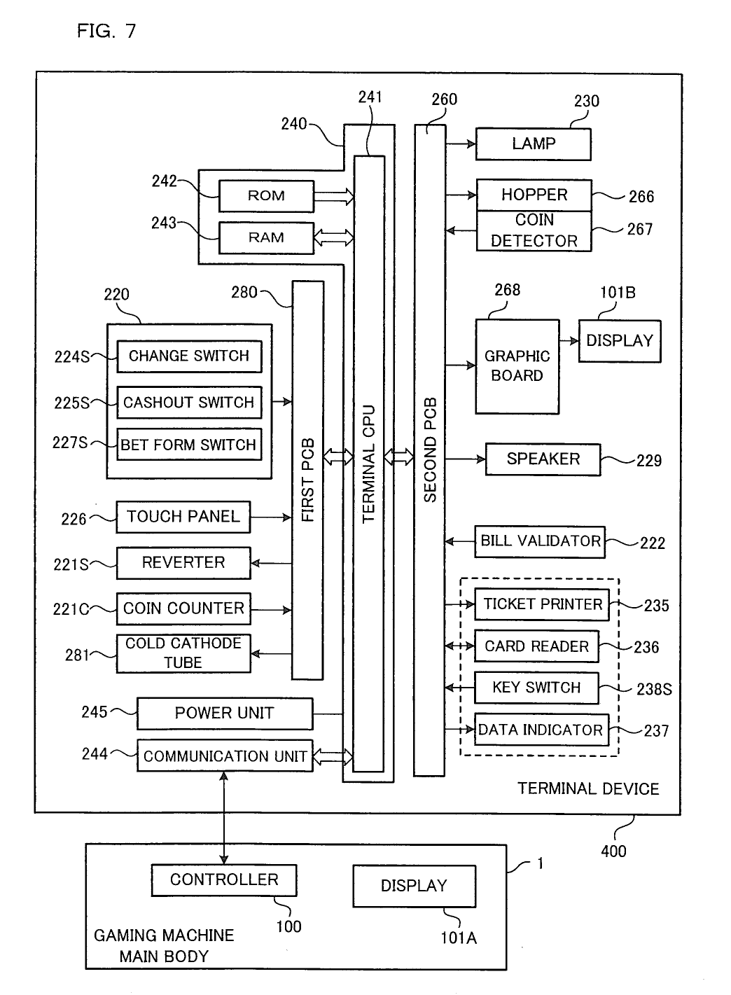

Each terminal device 400 provided to the gaming machine terminal 2 has a control unit shown in FIG. 7. The control unit has a mother board 240, a first PCB 280, a second PCB 260, various switches and a speaker 229. The motherboard 240 has a terminal CPU 241, a ROM 242 and a RAM 243. The terminal CPU 241 has a function as a controller controlling the overall terminal device 400.

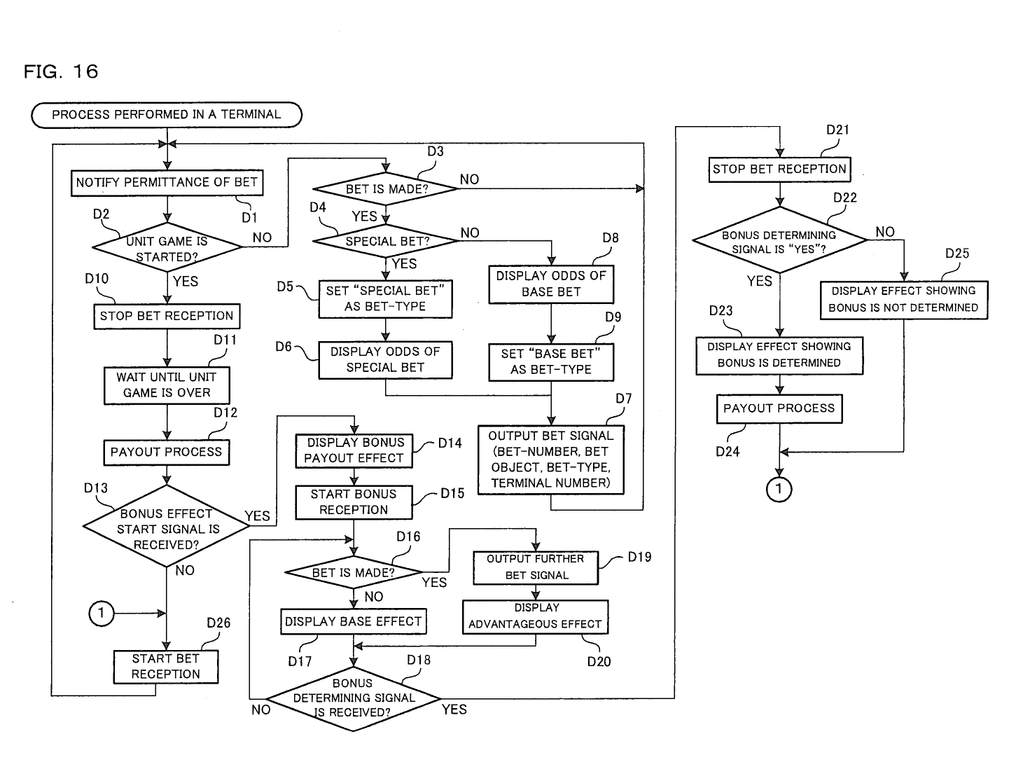

The ROM 242 stores a program such as BIOS (Basic Input/Output System) executed by the terminal CPU 241, a process routine of the terminal shown in FIG. 16 and data used permanently. When the BIOS is executed by the terminal CPU 241, each of peripheral devices is initialized. The RAM 243 stores data that is used when the terminal CPU 241 performs a process.

The terminal CPU 241 is connected to a communication unit 244. The communication unit 244 is provided to communicate with the gaming machine main body 1 through a communication line. Further, the motherboard 240 is connected to a power unit 245. When power is supplied to the motherboard 240 from the power unit 245, the terminal CPU 241 of the motherboard 240 is started.

The motherboard 240 is connected to the first PCB 280 and the second PCB 260 via a signal bus. The first PCB 280 is connected to a device or apparatus for producing an input signal that will be inputted to the terminal CPU 241, and a device or apparatus that is controlled by a control signal outputted from the terminal CPU 241. The terminal CPU 241 executes the game program and the game system program stored in the RAM 243, based on the input signal inputted to the terminal CPU 241, to carry out an arithmetic process, thereby storing a result thereof in the RAM 243 or a process of transmitting a control signal to each device or apparatus as a control process to each device or apparatus.

The second PCB 260 is connected to a lamp 230, a hopper 266, a coin sensor 267, a graphic board 268, the speaker 229, a bill validator 222, a ticket printer 235, a card reader 236, a key switch 238S and a data indicator 237.

The lamp 230 is turned on/off on the basis of the control signal outputted from the terminal CPU 241. The hopper 266 is mounted in the cabinet 3 and pays out predetermined number of coins to the coin tray 416, based on the control signal outputted from the terminal CPU 241. The coin sensor 267 detects that the predetermined number of coins are paid out and outputs an input signal to the terminal CPU 241.

The graphic board 268 controls an image display in the display 101B, based on the control signal outputted from the terminal CPU 241. In addition, the graphic board 268 is provided with a VDP for producing image data on the basis of the control signal outputted from the terminal CPU 241, a video RAM for temporarily storing the image data produced by the VDP, and the like.

The bill validator 222 reads an image of the bill and receives the genuine bill in the cabinet 3. In addition, when receiving the genuine bill, the bill validator 222 outputs an input signal to the terminal CPU 241, based on an amount of the bill. The terminal CPU 241 stores a credit-number, which corresponds to the amount of the bill transmitted by the input signal, in the RAM 43, and transmits the credit-number to the gaming machine main body 1 through the communication unit 244.

The ticket printer 235 prints a barcode having data encoded thereto, such as credit-number stored in the RAM 43, date and time, identification number of the gaming device 10 and the like, on a ticket, based on the control signal outputted from the terminal CPU 241, thereby outputting the ticket having the barcode.

The card reader 236 reads the data from the smart card to transmit it to the terminal CPU 241, and writes the data into the smart card, based on the control signal outputted from the terminal CPU 241. The key switch 238S is mounted to the keypad, and outputs an input signal to the terminal CPU 241 when the player manipulates the keypad. The data indicator 237 displays the data that is read by the card reader 236 or the data which the player inputs through the key switch 238S, based on the control signal outputted from the terminal CPU 241. In the mean time, the data is transmitted to the gaming machine main body 1 via the communication unit 244.

The first PCB 280 is connected to a control panel 220, a reverter 221S, a coin counter 221C and a cold cathode tube 281. The control panel 220 is provided with a change switch 224S corresponding to the change button, a cashout switch 225S corresponding to the cashout button and a BET form switch 227S corresponding to the BET form switch 227. Each of the switches 224S, 225S, and 227S outputs an input signal to the terminal CPU 241 when each of the corresponding buttons is operated by a player.

The coin counter 221C validates whether a coin, which is inserted by the player, is genuine or not. A coin which is not genuine is discharged to the coin tray 416. In addition, the coin counter 221C outputs an input signal to the terminal CPU 241 when it detects a genuine coin.

The coin counter 221C is operated on the basis of the control signal outputted from the terminal CPU 241 and distributes a coin, which is recognized as a genuine coin by the coin counter 221C, to a cash box or hopper 266 mounted in the gaming device 10. In other words, when the hopper 266 is filled with coins, a genuine coin is distributed into the cash box by the reverter 221S. On the other hand, when the hopper 266 is not fully filled with the coins, the genuine coin is distributed into the hopper 266. The cold cathode tube 281 functions as a backlight mounted to a rear end of the display 101B and is turned on, based on the control signal outputted from the terminal CPU 241.

(Data Table)

In the followings, a racer table of FIG. 8 will be described. The data in the table is stored in the RAM 43 of the gaming machine main body 1. The table has a column of IDs, a column of names, a column of winning averages and a column of effect data. The column of IDs stores identification numbers for identifying the racers uniquely. To be more specific, “01”, “02” to “99” are stored. The column of names stores names of racers. To be more specific, “horse 1”, “horse 2” to “horse 99” are stored. The column of winning averages stores number data indicating winning averages of racers. A winning average is used to determine whether a racer wins a race. In other words, the winning average is data that is used to determine a win BET object 173 from the BET objects 170. The column of effect data stores image data relating to an effect of a racer. The image data is used to perform an effect relating to a racer, for example to display an effect 181 in which it is advantageous for a racer to acquire a bonus payout.

Note that, in this embodiment, the racer table is described as above; however, these are a part of a racer table, and the present invention is not limited thereto.

In the followings, a bonus determination table (base) of FIG. 9 will be described. The data in the table are stored in the RAM 43 of the gaming machine main body 1. The table has a determination column and a column of random number range. The determination column stores data indicating whether to determine a bonus. To be more specific, the data indicating “to award a bonus” and “not to award a bonus” are stored. The column of random number range stores data indicating a range of random numbers. The random number range is used to determine whether a generated random number is within the corresponding range of random numbers. In other words, it is the data that is used to determine whether to award a bonus payout. To be more specific, the data indicating the range of random numbers, such as “0 to 50” and “51 to 1000” are stored.

In the followings, a bonus determination table (advantage) will be described. The data in the table are stored in the RAM 43 of the gaming machine main body 1. The table has a determination column and a column of random number range. The determination column stores data indicating whether to determine a bonus. To be more specific, the data indicating “to award a bonus” and “not to award a bonus” are stored. The column of random number range stores data indicating a range of random numbers. The random number range is used to determine whether a random number generated is within the corresponding range of random numbers. In other words, it is the data that is used to determine whether to award a bonus payout. To be more specific, the data indicating the range of random numbers, such as “0 to 100” and “101 to 1000” are stored.

Like this, the bonus determination table (advantage) of FIG. 10 is set in such a manner that a probability of determining “to award a bonus” is higher than in the bonus determination table (base) of FIG. 9.

In the mean time, the present invention is not limited to the bonus determination table as described above. For example, an appropriate bonus determination table may be designed in accordance with a method of determining a bonus payout.

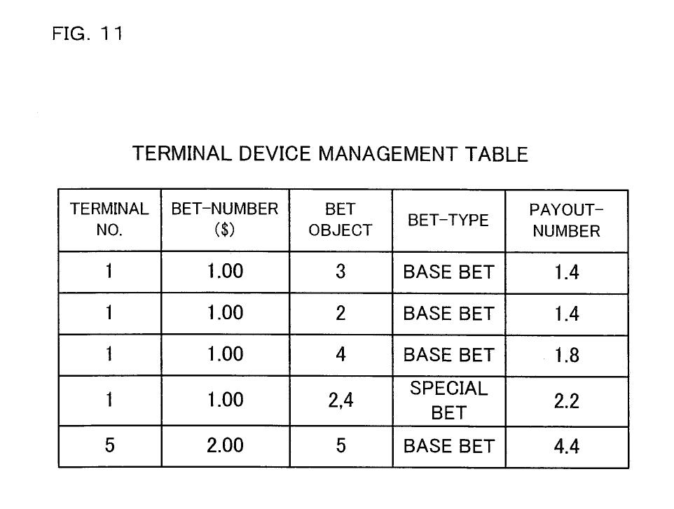

In the followings, a terminal device management table of FIG. 11 will be described. The data in the table are stored in the RAM 43 of the gaming device main body 1. The table has a column of terminal numbers, a column of bet-numbers, a column of BET objects, a column of bet-types, and a column of payout-numbers. The column of terminal devices stores terminal numbers inherent to the respective terminal devices 400. To be more specific, “1” and “5” are stored. The column of bet-numbers stores a game value bet on a BET object 150, as a numerical value. The column of BET objects stores data specifying a BET object 170 bet. The column of bet-types stores data for identifying whether a BET object 170 bet is bet as a special BET 172 or base BET 171. The column of payout-numbers stores an amount of a game value that is paid out when a BET object 170 is same as a win BET object 173.

In the mean time, “0” is stored which indicates that no payout is awarded when a BET object 170 cannot be same as a win BET object 173.

In addition, the present invention is not limited to the terminal device management table as described above. For example, an appropriate management table may be designed in accordance with a method of managing the terminal information.

(Process Operation of the Gaming Machine Main Body 1)

In the followings, a process that is performed in the gaming machine main body 1 will be described. The main CPU 41 of the controller 100 reads out and executes a game program, thereby proceeding with a game.

(Process Operation of the Gaming Machine Main Body 1: a Main Process Routine Performed in the Main Body)

As shown in FIG. 12, in a main process routine performed in the main body, the main CPU 41 determines a playing racer and odds (S1). A racer to be used in a unit game is, for example randomly determined from the racer table shown in FIG. 8 and a BET object 170 is determined based on the racer determined. Based on the BET object 170 determined and the racer table, the odds, i.e., a payout ratio 175 is determined.

Next, the main CPU 41 waits for a start of a unit game until the bet receiving time is over. During the bet receiving time, a bet is received through a push of the touch panel 226 and the like in the terminal device 400. A detailed operation of the terminal device 400 will be described later.

Then, the main CPU 41 outputs a unit game start signal, which shows a start of a unit game, to the terminal device 400 (S3). Thereby, the terminal device 400 can recognize that a unit game has started in the gaming machine main body 1. Then, as shown in a top-middle of FIG. 4, a race effect is displayed on the display 101A (S4). Then, an arrival order of the racers is determined (S5). In other words, based on an execution result of a game, a win BET object 173 is determined from the BET objects 170. Then, based on the arrival order determined, an effect about a game result is displayed on the display 101A, as shown in a top-right of FIG. 4. Then, a unit game end signal is outputted to the terminal device 400 (S7). Thereby, the terminal device 400 can recognize that a unit game is over in the gaming machine main body 1. Then, a payout-number calculating process routine is executed (S8). The payout-number calculating process routine will be described later.

The main CPU 41 determines whether the BET object 170 bet as a special BET 172 wins, when the payout-number calculating process routine is ended (S9). In other words, it is determined whether the BET object 170 bet as a special BET 172 is same as the win BET object 173 determined. When it is determined that the BET object 170 bet as a special BET 172 wins (S9: YES), a bonus payout determining process is executed (S10) and the process returns to the step of S1.

On the other hand, when it is determined that the BET object 170 bet as a special BET 172 does not win (S9: NO), the process returns to the step of S1.

In the mean time, in this embodiment of the present invention, it is determined whether to execute a bonus payout determining process, in the step of S9 of the main process that is performed in the main body. However, a first main process performed in the main body, which always executes a bonus payout determining process, and a second main process performed in the main body, which does not always execute a bonus payout determining process may be stored in the RAM 43 and one of the first and second main processes may be executed on the basis of whether a bet is made as a special BET 172.

(Process Operation of the Gaming Machine Main Body 1: Payout-Number Calculating Process Routine)

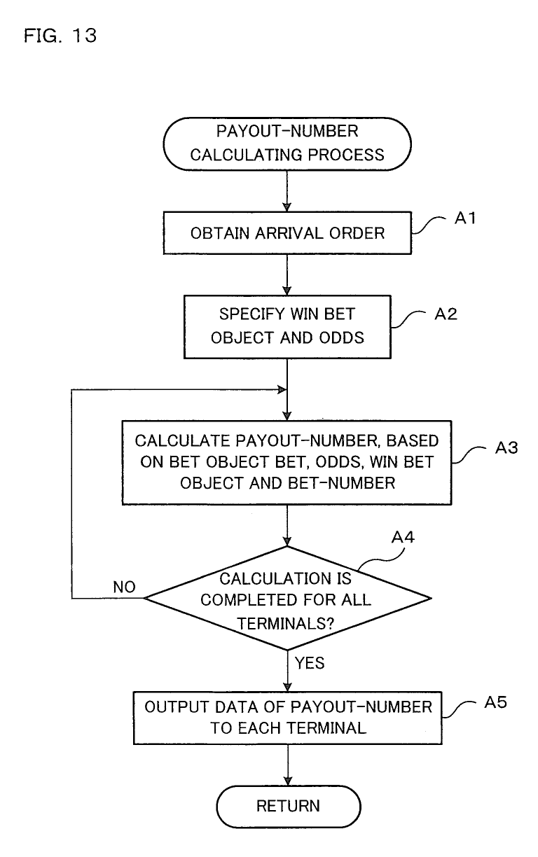

When the payout-number calculating process routine is executed in the main process routine that is performed in the main body, which is shown in FIG. 12, the main CPU 41 obtains the data of the arrival order (A1), as shown in FIG. 13. Then, a win BET object 173 and an odds thereof (payout ratio 175) are specified (A2).

Then, the main CPU 41 calculates a payout-number, based on the BET object 170 bet and the odds (payout ratio 175), a win BET object 173, and a bet-number, for each terminal device 400 (A3). Specifically, based on the data of the terminal device management table stored in the RAM 43 and the win BET object 173 specified, the main CPU 41 calculates a payout-number for each terminal number.

The main CPU 41 performs the step of A3 until the calculation is completed for all the terminal devices 400 in the step of A3 (A4: NO). When it is determined that the calculation is completed for all the terminal devices 400 (A4: NO), the data of the payout-number calculated is outputted to each of the terminal devices 400 (A5). Then, this routine is ended and the process returns to the main process routine that is performed in the main body.

(Process Operation of the Gaming Machine Main Body 1: BET Process Routine)

In addition, the controller 100 executes a BET process routine, independently from the main process routine that is performed in the main body, so as to manage a BET situation in each terminal device 400.

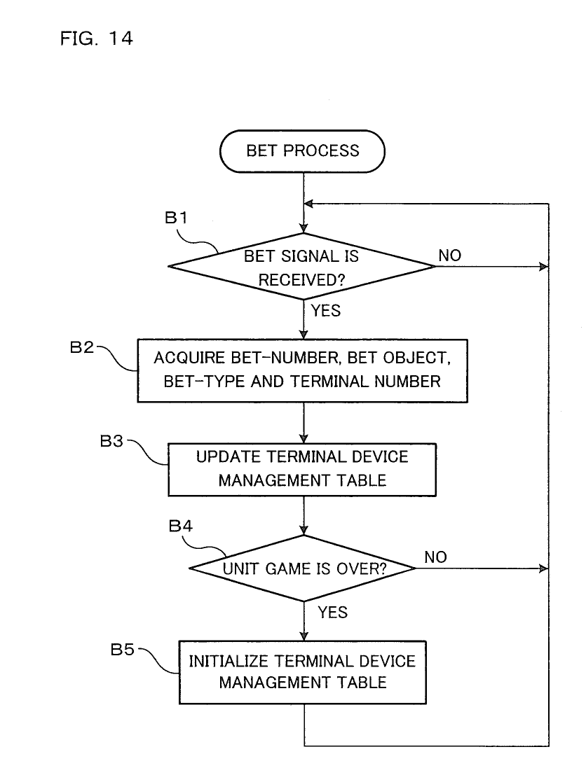

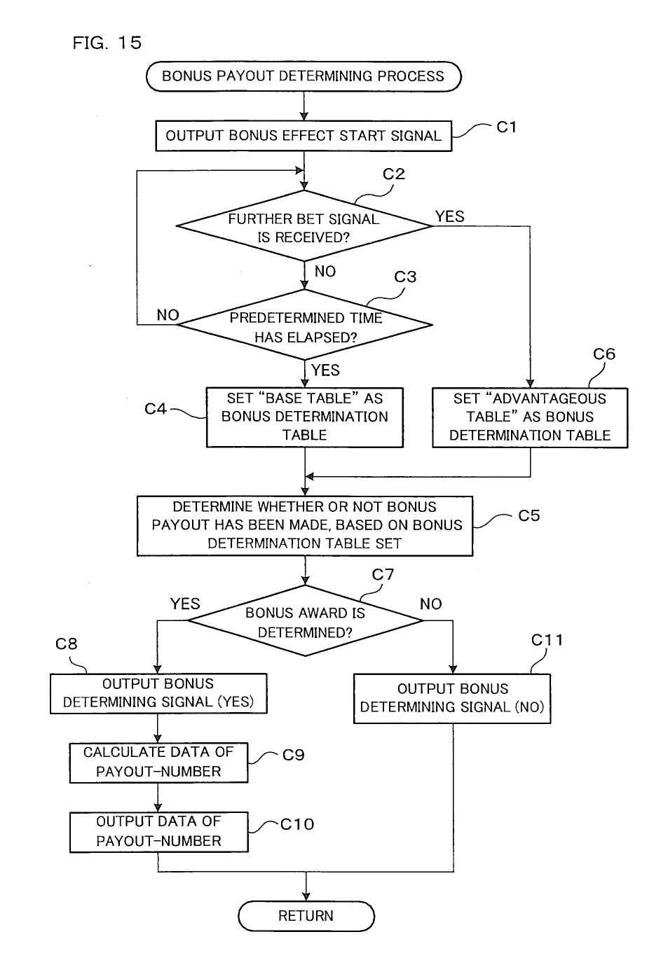

As shown in FIG. 14, when a BET process routine is executed, the main CPU 41 determines whether a BET signal is received from the terminal device 400 (B1). When it is determined that a BET signal is not received (B1: NO), the process returns to the step of B1.

On the other hand, when a BET signal is received (B1: YES), the main CPU 41 obtains a variety of data of a bet-number, a BET object 170, a bet-type and a terminal number included in the BET signal (B2). Then, the data of the terminal device management table shown in FIG. 4, which is stored in the RAM 43, is updated using the data (B3).

Then, the main CPU 41 determines whether a unit game is over (B4). To be more specific, when a unit game end signal is received, it is determined that a unit game is over. When it is determined that a unit game is not over (B4: NO), the process returns to the step of B1.

On the other hand, when it is determined that a unit game is over (B4: YES), the terminal device management table is initialized (B5) and the process returns to the step of B1. The controller 100 manages the bet-number and the like of each terminal device 400, thereby enabling a payout-number to be calculated when a win is made.

(Process Operation of the Gaming Machine Main Body 1: Bonus Payout Determining Process Routine)

In the main process routine that is performed in the main body, which is shown in FIG. 12, when a bonus payout determining process routine is executed, the main CPU 41 outputs a bonus effect start signal to the terminal device 400 in which the BET object 170 bet as a special BET 172 wins (C1). Thereby, the terminal device 400 can displays a bonus payout effect and start a bet reception.

Next, it is determined whether a further BET signal is received from the terminal device 400 (C2). When it is determined that a further BET signal is not received (C2: NO), it is determined whether a predetermined time has elapsed after a bonus effect start signal is outputted (C3). When it is determined that a predetermined time has not elapsed (C3: NO), the process returns to the step of C2. On the other hand, when it is determined that a predetermined time has elapsed (C3: YES), the bonus determination table (base) is set to the bonus determination table that is stored in the RAM 43 (C4), and the step of C5 is executed.

In the mean time, in the process of C2, when it is determined that a further BET signal is received (C2: YES), the bonus determination table (advantage) shown in FIG. 10 is set to the bonus determination table stored in the RAM 43 (C5), and the step of C5 is executed.

When the step of C4 or C6 is executed, it is determined whether to award a bonus payout, based on the bonus determination table that is stored in the RAM 43 (C5). To be more specific, a random number within a range of 0 to 1000 is generated and it is determined whether to award a bonus payout, based on the generated random number and the bonus determination table.

Then, it is determined whether a bonus award is determined (C7). When it is determined that a bonus award is determined (C7: YES), a bonus determination signal (yes) is outputted to the terminal device 400 for which a bonus award is determined (C8), a payout-number is calculated (C9), the data of the payout-number is outputted to the terminal device 400 for which a bonus award is determined (C10) and this routine is ended.

On the other hand, when it is determined in the step of C7 that a bonus award is not determined (C7: NO), a bonus determination signal (no) is outputted (C11) and this routine is ended.

Thereby, based on whether or not a bet of a game value has been made, it is possible to randomly determine whether to award a bonus payout. When it is determined that a bonus payout is awarded, the terminal device 400 can award a bonus payout.

(Process Routine of the Gaming Machine Terminal 2: Process Routine that is Performed in the Terminal)

In the followings, a process that is performed in each terminal device 400 of the gaming machine terminal 2 cooperating with the gaming machine main body 1 will be described. When each terminal device 400 serving as the BET receiver 400 executes a process routine that is performed in the terminal, which is shown in FIG. 16, the terminal CPU 241 notifies that a bet can be made by displaying on the display 101B (D1).

Then, the terminal CPU 241 determines whether a unit game is started in the gaming machine main body 1 (D2). To be more specific, when a unit game start signal is received from the gaming machine main body 1, it is determined that a unit game is started. When it is determined that a unit game is not started (D2: NO), it is determined whether there is a bet (D3). When it is determined that there is no bet (D3: NO), the process returns to the step of D1.

On the other hand, when it is determined that there is a bet (D3: YES), it is determined whether the bet is a special BET 172 (D4). When it is determined that the bet is a special BET (D4: YES), a “special BET” is set to a bet-type (D5), the odds (payout ratio 175) of the special BET 172 is displayed on the display 101B (D6) and the step of D7 is executed.

On the other hand, when it is determined that the bet is not a special BET (D4: NO), a “base BET” is set to a bet-type (D8), the odds (payout ratio 176) of the base BET 171 is displayed on the display 101B (D9) and the step of D7 is executed.

When the step of D6 or D7 is executed, the terminal CPU 241 outputs a BET signal to the gaming machine main body 1 (D7) and returns to the step of D1. The BET signal includes a bet-number indicating a game value bet, a BET object 170 bet, a bet-type set and a terminal number. Thereby, the gaming machine main body 1 can store the information about the bet in the terminal device management table.

On the other hand, when it is determined in the step of D2 that a unit game is started (D2: YES), a bet reception is stopped (D10) and the wait state is sustained until a unit game end signal is received (D11). When a unit game end signal is received, a payout process of paying out a coin is executed, based on the data of the payout-number received (D12).

Then, it is determined whether a bonus effect start signal is received from the gaming machine main body 1 (D13). When it is determined that a bonus effect start signal is not received (D13: NO), a bet reception is started (D26) and the process returns to the step of D1.

On the other hand, when it is determined in the step of D13 that a bonus effect start signal is received (D13: YES), a bonus payout is displayed on the display 101B, as shown in FIG. 5 (D14). In addition, a bet reception is started (D15), as shown in FIG. 5. Then, it is determined whether a bet is made or not (D16). When it is determined that a bet is not made (D16: NO), a base effect is displayed on the display 101B (D17), as shown in a bottom-left of FIG. 5.

Then, it is determined whether a bonus determination signal is received from the gaming machine main body 1 (D18). When it is determined that a bonus determination signal is not received (D18: NO), the process returns to the step of D16.

On the other hand, when it is determined in the step of D16 that a bet is made (D16: YES), a further bet signal is outputted to the gaming machine main body 1 (D19). Then, an advantageous effect 181 is displayed on the display 101B (D20) and the step of D18 is executed.

When it is determined in the step of D18 that a bonus determination signal is received (D18: YES), a bet reception is stopped (D21) and it is determined whether the bonus determination signal received is a “bonus determination signal (yes)” (D22). When it is determined that the bonus determination signal received is a “bonus determination signal (yes)” (D22: YES), an effect indicating that a bonus is determined is displayed on the display 101B (D23). Then, based on the data of the payout-number received, a payout process of paying out a coin is executed (D24) and then a step of D26 is executed.

On the other hand, when it is determined in the step of D22 that the bonus determination signal received is not a “bonus determination signal (yes)” (D22: NO), an effect indicating that a bonus is not determined is displayed on the display 101B (D25) and then a step of D26 is executed.

As described above, a game can be provided in which by making a bet on a BET object as a special BET, an award of a bonus payout may be determined although a payout ratio for the bet made as a special BET is different from a payout ratio for the bet made as a base BET. Therefore, it is possible to give a player an expectation that a bonus payout may be awarded, in addition to the characteristics of a conventional game, without deteriorating the conventional game characteristic.

Furthermore, the bonus payout is determined on the basis of whether or not the bet of game value has been made. This encourages a player to bet a game value so that the bonus payout is determined.

Furthermore, an effect in which a racer intends to acquire a bonus payout and an effect in which it is advantageous for the racer to acquire the bonus payout are displayed on the display, This encourages a player to bet a game value. In addition, this may cause the player to feel a strong attachment to the racer.

Further, a payout ratio of the special BET is smaller than a payout ratio of the base BET and a bonus award is determined on the basis of whether or not a bet of a game value has been made. This may encourage a player, who wants to acquire a payout based on a payout ratio of a base BET, to bet a game value.

In the mean time, although the above descriptions have been provided with regard to the characteristic parts so as to understand the invention more easily, the invention is not limited to the embodiment as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

In addition, the above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A gaming device comprising:
a game in which a player is able to bet a game value on a BET object;
a BET receiver that receives, from an outside, a bet of the game value on the BET object, as a base BET when an operation of betting the game value on the BET object is a base operation and as a special BET when an operation of betting the game value on the BET object is a special operation; and
a controller programmed to operate:
(a1) regarding a payout ratio corresponding to the BET object, to set a payout ratio for a bet made as the base BET so as to be different from a payout ratio for a bet made as the special BET;
(a2) to control the BET receiver to receive a bet of the game value on the BET object from the outside, as the base BET, when an operation of betting the game value on the BET object is a base operation, and as the special BET, when an operation of betting the game value on the BET object is a special operation;
(a3) to determine a win BET object from the BET objects, based on an execution result of the game;
(a4) when the win BET object is same as the BET object bet, to award a payout, based on the payout ratio corresponding to the BET object bet and the game value that is bet on the BET object bet;
(a5) when the win BET object is same as the BET object bet as the special BET, to randomly determine whether to award a bonus payout; and
(a6) when it is determined that the bonus payout is awarded, to award the bonus payout.

2. A gaming device comprising:
a game in which a player is able to bet a game value on a BET object;
a BET receiver that receives, from an outside, a bet of the game value on the BET object, as a base BET when an operation of betting the game value on the BET object is a base operation and as a special BET when an operation of betting the game value on the BET object is a special operation; and
a controller programmed to operate:
(b1) regarding a payout ratio corresponding to the BET object, to set a payout ratio for a bet made as the special BET so as to be smaller than a payout ratio for a bet is made as the base BET;
(b2) to control the BET receiver to receive a bet of the game value on the BET object from the outside, as the base BET, when an operation of betting the game value on the BET object is a base operation, and as the special BET, when an operation of betting the game value on the BET object is a special operation;
(b3) to determine a win BET object from the BET objects, based on an execution result of the game;
(b4) when the win BET object is same as the BET object bet, to award a payout, based on the payout ratio corresponding to the BET object bet and the game value that is bet on the BET object bet;
(b5) when the win BET object is same as the BET object bet as the special BET, to randomly determine whether to award a bonus payout; and
(b6) when it is determined that the bonus payout is awarded, to award the bonus payout.

3. A gaming device comprising:
a game in which a player is able to bet a game value on a BET object;
a BET receiver that receives, from an outside, a bet of the game value on the BET object, as a base BET when an operation of betting the game value on the BET object is a base operation and as a special BET when an operation of betting the game value on the BET object is a special operation; and
a controller programmed to operate:
(c1) regarding a payout ratio corresponding to the BET object, to set a payout ratio for a bet made as the base BET so as to be different from a payout ratio for a bet made as the special BET;
(c2) to control the BET receiver to receive a bet of the game value on the BET object from the outside, as the base BET, when an operation of betting the game value on the BET object is a base operation, and as the special BET, when an operation of betting the game value on the BET object is a special operation;
(c3) to determine a win BET object from the BET objects, based on an execution result of the game;
(c4) when the win BET object is same as the BET object bet, to award a payout, based on the payout ratio corresponding to the BET object bet and the game value that is bet on the BET object bet;
(c5) when the win BET object is same as the BET object bet as the special BET, to control the BET receiver to receive a bet of the game value;
(c6) to randomly determine whether to award a bonus payout, based on whether or not the bet of the game value has been made; and
(c7) when it is determined that the bonus payout is awarded, to award the bonus payout.

4. The gaming device according to claim 3, wherein the controller is programmed to operate:
(d1) regarding a payout ratio corresponding to the BET object, to set a payout ratio for a bet made as the special BET so as to be smaller than a payout ratio for a bet made as the base BET;
(d2) to control the BET receiver to receive a bet of the game value on the BET object from the outside, as the base BET, when an operation of betting the game value on the BET object is a base operation, and as the special BET, when an operation of betting the game value on the BET object is a special operation;
(d3) to determine a win BET object from the BET objects, based on an execution result of the game;
(d4) when the win BET object is same as the BET object bet, to award a payout, based on the payout ratio corresponding to the BET object bet and the game value that is bet on the BET object bet;
(d5) when the win BET object is same as the BET object bet as the special BET, to control the BET receiver to receive a bet of the game value;
(d6) to randomly determine whether to award a bonus payout, based on whether or not the bet of the game value has been made; and
(d7) when it is determined that the bonus payout is awarded, to award the bonus payout.

5. A gaming device comprising:
a game in which a racer is able to race and a player is able to bet a game value on a BET object corresponding to a result of the race;
a display capable of displaying an effect about the game;
a BET receiver that receives, from an outside, a bet of the game value on the BET object, as a base BET, when an operation of betting the game value on the BET object is a base operation, and as a special BET, when an operation of betting the game value on the BET object is a special operation; and
a controller programmed to operate:
(e1) regarding a payout ratio corresponding to the BET object, to set a payout ratio for a bet made as the base BET so as to be different from a payout ratio for a bet made as the special BET;
(e2) to control the BET receiver to receive a bet of the game value on the BET object from the outside, as the base BET, when an operation of betting the game value on the BET object is a base operation, and as the special BET, when an operation of betting the game value on the BET object is a special operation;
(e3) to determine a win BET object from the BET objects, based on an execution result of the game;
(e4) when the win BET object is same as the BET object bet, to award a payout, based on the payout ratio corresponding to the BET object bet and the game value that is bet on the BET object bet;
(e5) when the win BET object is same as the BET object bet as the special BET, to control the BET receiver to receive a bet of the game value and to control the display to display an effect in which the racer intends to acquire a bonus payout;
(e6) when the bet of the game value is received, to control the display to display an effect in which it is advantageous for the racer to acquire the bonus payout;
(e7) to randomly determine whether to award a bonus payout, based on whether or not the bet of the game value has been made; and
(e8) when it is determined that the bonus payout is awarded, to award the bonus payout.

6. A gaming device comprising:
a game in which a racer is able to race and a player is able to bet a game value on a BET object corresponding to a result of the race;
a display capable of displaying an effect about the game;
a BET receiver that receives, from an outside, a bet of the game value on the BET object, as a base BET, when an operation of betting the game value on the BET object is a base operation, and as a special BET, when an operation of betting the game value on the BET object is a special operation; and
a controller programmed to operate:
(f1) regarding a payout ratio corresponding to the BET object, to set a payout ratio for a bet made as the base BET so as to be smaller than a payout ratio for a bet made as the special BET;
(f2) to control the BET receiver to receive a bet of the game value on the BET object from the outside, as the base BET, when an operation of betting the game value on the BET object is a base operation, and as the special BET, when an operation of betting the game value on the BET object is a special operation;
(f3) to determine a win BET object from the BET objects, based on an execution result of the game;
(f4) when the win BET object is same as the BET object bet, to award a payout, based on the payout ratio corresponding to the BET object bet and the game value that is bet on the BET object bet;
(f5) when the win BET object is same as the BET object bet as the special BET, to control the BET receiver to receive a bet of the game value and to control the display to display an effect in which the racer intends to acquire a bonus payout;
(f6) when the bet of the game value is received, to control the display to display an effect in which it is advantageous for the racer to acquire the bonus payout;
(f7) to randomly determine whether to award a bonus payout, based on whether or not the bet of the game value has been made; and
(f8) when it is determined that the bonus payout is awarded, to award the bonus payout.

7. A playing method of a gaming device having a game in which a player is able to bet a game value on a BET object, the method comprising the steps of: (g1) with regard to a payout ratio corresponding to the BET object, setting a payout ratio for a bet made as a base BET so as to be different from a payout ratio for a bet made as a special BET;
(g2) controlling a BET receiver to receive a bet of the game value on the BET object from the outside, as the base BET, when an operation of betting the game value on the BET object is a base operation, and as the special BET, when an operation of betting the game value on the BET object is a special operation;
(g3) determining a win BET object from the BET objects, based on an execution result of the game;
(g4) when the win BET object is same as the BET object bet, awarding a payout, based on the payout ratio corresponding to the BET object bet and the game value that is bet on the BET object bet;
(g5) when the win BET object is same as the BET object bet as the special BET, randomly determining whether to award a bonus payout; and
(g6) when it is determined that the bonus payout is awarded, awarding the bonus payout.

8. A gaming device comprising:
a game in which a player is able to bet a game value on a BET object;
a switch capable of accepting at least two forms from an outside;
a BET receiver that receives, from the outside, a bet of the game value on the BET object; a memory device that stores a first game program executing the game having a possibility that a bonus payout may be awarded and a second game program executing the game having no possibility that a bonus payout is awarded; and
a controller programmed to operate:
(h1) to control the BET receiver to receive a bet of the game value on the BET object from the outside;
(h2) when an input form of the switch is one form, to execute the first game program stored in the memory device, and when an input form of the switch is an other form, to execute the second game program stored in the memory device;
(h3) to determine a win BET object from the BET objects, based on an execution result of the first or second game program;
(h4) when the win BET object is same as the BET object bet, to award a payout, based on a predetermined condition;
(h5) when the second game program is executed and the win BET object is same as the BET object bet, to randomly determine whether to award a bonus payout; and
(h6) when it is determined that the bonus payout is awarded, to award the bonus payout.

9. A gaming device comprising:
a game in which a player is able to bet a game value on a BET object;
a switch capable of accepting at least two forms from an outside;
a BET receiver that receives, from the outside, a bet of the game value on the BET object; a memory device that stores a first game program executing the game having a possibility that a bonus payout may be awarded and a second game program executing the game having no possibility that a bonus payout is awarded; and
a controller programmed to operate:
(i1) to control the BET receiver to receive a bet of the game value on the BET object from the outside;
(i2) when an input form of the switch is one form, to execute the first game program stored in the memory device, and when an input form of the switch is an other form, to execute the second game program stored in the memory device;
(i3) to determine a win BET object from the BET objects, based on an execution result of the first or second game program;
(i4) when the win BET object is same as the BET object bet, to award a payout, based on a predetermined condition;
(i5) when the second game program is executed and the win BET object is same as the BET object bet, to control the BET receiver to receive a bet of the game value;
(i6) to randomly determine whether to award a bonus payout, based on whether or not a bet of the game value has been made; and
(i7) when it is determined that the bonus payout is awarded, to award the bonus payout.

10. A playing method of a gaming device having a game in which a player is able to bet a game value on a BET object, the method comprising the steps of:
(j1) controlling a BET receiver to receive a bet of the game value on the BET object from an outside;
(j2) when an input form of a switch capable of accepting at least two forms from an outside is one form, executing a first game program executing the game having a possibility that a bonus payout may be awarded, and when an input form of the switch is an other form, executing a second game program executing the game having no possibility that a bonus payout is awarded;
(j3) determining a win BET object from the BET objects, based on an execution result of the first or second game program;
(j4) when the win BET object is same as the BET object bet, awarding a payout, based on a predetermined condition;
(j5) when the second game program is executed and the win BET object is same as the BET object bet, randomly determining whether to award a bonus payout; and
(j6) when it is determined that the bonus payout is awarded, awarding the bonus payout.
